(19) United States
(12) Patent Application Publication
(10) Pub. No.: US 2026/0301132 A1
(43) Pub. Date: Oct. 1, 2026

(54) Hologram Processing

(71) Applicant: Envisics Ltd, Milton Keynes (GB)

(72) Inventors: Jamieson Christmas, Milton Keynes (GB); Ruisheng Lin, Milton Keynes (GB)

(21) Appl. No.: 19/479,670

(22) PCT Filed: May 9, 2024
(86) PCT No.: PCT/EP2024/062860

§ 371 Date: Oct. 28, 2025

(30) Foreign Application Priority Data
May 18, 2023 (GB) 2307419.8

(51) Int. Cl. G06T 5/70; G06T 5/20; G09G 3/00

(52) U.S. Cl. CPC G06T 5/70; G06T 5/20; G09G 3/001

(57) ABSTRACT

There is provided a light engine comprising a display device. The display device comprises an array of pixel. Each pixel is for applying a phase delay to light incident thereon. The light engine is configured to receive a hologram of a picture. The hologram comprises an array of pixel values. The hologram comprises a first area comprising diffractive content and a second area comprising non-diffractive content. The first area is adjacent to the second area. The light engine is further arranged to apply a hologram blurring function to the hologram in a boundary area of the first and second areas to output a modified hologram. The hologram blurring function is arranged to change a gradient of the pixel values in the boundary area.

### FIELD

The present disclosure relates to a light engine, a method, and a (processed) diffractive structure. More specifically, the present disclosure relates to a light engine arranged to process a hologram to prevent stray or unwanted light—e.g. scattered light—from reaching a viewing window of the light engine. Some embodiments relate to a holographic projector, picture generating unit or head-up display.

### BACKGROUND AND INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

In general terms, there is provided a light engine for receiving a hologram of a picture, the hologram comprising a first area and a second area. In embodiments, the hologram comprises an array of pixel values. Each pixel value may be or represent a phase delay. The light engine is arranged to apply a hologram blurring function to a boundary area of the first area and the second area of the hologram. The hologram blurring function is arranged to change a gradient (i.e. rate of change) of pixel values of the hologram in (e.g. across) the boundary area. In some embodiments, the hologram blurring function is arranged to reduce the magnitude/size of one or more phase differences between adjacent pixel values of the hologram in the boundary area. In some embodiments, the hologram blurring function is arranged to reduce the size of a step change in pixel values at a boundary/border between the first area and the second area of the hologram. In some embodiments, the hologram blurring function reduces the maximum pixel value difference between adjacent pixels in or across the boundary. In some embodiments, the function increases the number of pixels associated with the boundary by extending or spreading a pixel value change (associated with the boundary) across more pixels. In the absence of the hologram blurring function, there may be a relatively large/sudden (step) change in pixel values at a border between the first area and the second area. For example, in some embodiments, the first area may be a diffractive area and the second area may be a non-diffractive area. In embodiments, the diffractive area is a pixel area in which hologram content has been calculated (and/or displayed) and the non-diffractive area is a pixel area in which hologram content has not been calculated (and/or displayed). In embodiments, there is no overlap between diffractive areas and non-diffractive areas, and the diffractive areas and non-diffractive areas collectively make up the entirely of the display area. However, for the avoidance of doubt, the boundary area in accordance with this disclosure may overlap one or both of a diffractive area and non-diffractive area. Pixel values of the hologram in the diffractive area may substantially vary across the diffractive area (from pixel value to pixel value). This may be such that light, incident on the diffractive area, is diffracted as a result of the differences between adjacent pixel values. Pixel values of the hologram in the non-diffractive area may by substantially constant, such that each pixel value in the non-diffractive area is substantially the same. This may be such that light incident on the non-diffractive area is not diffracted. Thus, at the border between the first (diffractive) area and the second (non-diffractive) area, there may be a step change in pixel value for adjacent or nearby pixels across the border between the first and second areas (in the absence of hologram blurring). For example, in the second area, each pixel value may be zero. In the first area, each pixel value may have a value of between 0 and 2π. As will be clear to the skilled reader, if a pixel in the first area, at a border between the first and second area, has a pixel value of 2π, then the (step) change in difference between that pixel and an adjacent pixel of the second area will be 2π. The application of the hologram blurring function, as described in more detail herein, reduces the size/magnitude of these changes by blurring or smoothing edges of the hologram at the border (i.e. blurring or smoothing boundaries between diffractive and non-diffractive areas of the hologram). The inventors have found that blurring the edges of a hologram using a hologram blurring function advantageously substantially reduces a so-called “halo effect” (noise) from appearing in a holographic reconstruction of the hologram. This halo effect is described in more detail herein.

The use of a hologram blurring function according to the present disclosure was counter-intuitive. The hologram may be a hologram of a picture and may be arranged such that, when the hologram is displayed on a display device, light incident thereon is spatially modulated in accordance with the hologram to form a holographic wavefront. The holographic wavefront may then form a holographic reconstruction of the picture. The quality of the holographic reconstruction of the picture depends on the amount of (phase) information contained in the hologram and the quality of that information. In other words, the quality of the holographic reconstruction may depend on the number of pixel values of the hologram used to form the reconstruction, and the accuracy of the pixel values themselves. As such, it is conventional in holographic projection to maximise the number of pixel values of a hologram used to form a holographic reconstruction and to ensure that those pixels values are as accurate as possible to ensure a good quality holographic reconstruction. Furthermore, the process of forming the holographic reconstruction is fundamentally based on diffraction which relies on well-defined diffractive structures such as changes in phase-delay. However, the hologram blurring function of the present disclosure changes pixel values of the hologram (in the boundary area) and so reduces the number and the accuracy of pixel values available to contribute to a holographic reconstruction. This amounts to blurring the diffractive structure. Thus, there was significant prejudice in the field leading the inventors away from using the hologram blurring function according to the present disclosure. However, the inventors have found that the advantage of applying the hologram blurring function to reduce the halo effect significantly outweigh the loss/reduction in the quality/quantity of phase information available for the holographic reconstruction. Furthermore, the inventors have found that the amount of pixel values that need blurring to substantially reduce halo is such as to not significantly adversely affect the appearance of the holographic reconstruction (to the naked eye).

As will also be described in more detail below, the inventors have found that the so-called halo effect may be particularly evident in (unusual) arrangements in which the hologram is arranged to form a holographic reconstruction relatively close to the display device (for example, when the distance between the display device and a holographic reconstruction is less than 50 millimetres, optionally less than 20 millimetres). So, the use of the hologram blurring function to reduce the magnitude of changes in pixel (phase) phase, and so to significantly reduce the halo effect, may be particularly advantageous in such (unusual) arrangements.

In some embodiments, the light engine comprises a viewing window. The light engine is arranged to display a hologram of a picture on a display device and to spatially modulate light in accordance with that hologram. The light engine is further arranged such that the spatially modulated light forms a holographic reconstruction on a replay plane. The picture comprises one or more areas containing (picture) content (content areas) and one or more areas without (picture) content (non-content areas). In such cases, the holographic reconstruction of the picture ideally comprises corresponding content areas and non-content areas. The above described diffractive areas of the hologram may form the content areas of the holographic reconstruction.

In some embodiments, the light engine may comprise one or more waveguide pupil expanders. The spatially modulated light may be relayed to and coupled into a first waveguide. The first waveguide may replicate that light to expand an exit pupil of the optical system in a first direction. A second waveguide may also be provided arranged to receive the light output from the first waveguide to expand the exit pupil of the optical system in a second direction. Conceptually, the result of this may be considered the creation of an array of replicas of the display device/replicas of the hologram displayed on the display device. The array of replicas may be said to exist on a “virtual surface” which may be staggered as explained in British patent application, GB2118911.3 filed on 23 Dec. 2021. In particular, each replica may be a different perpendicular distance from the display device owing to different path lengths in the waveguide associated with each replica. Thus, the part of the virtual surface (e.g. in the x, y dimensions) associated with each replica is offset from the display device in the perpendicular direction (e.g. in the z dimension). A virtual image of the holographic reconstruction is visible when a viewing system (such as the eye of a user) is positioned at a viewing window downstream of the waveguide/s. The virtual image may be formed at a virtual image distance upstream of the display device. Typically, the virtual image distance may be between about 1 metre and about 10 or 20 metres. One of the advantages of the above optical system (comprising one or more waveguides) is that it increases the viewing window (i.e., a user's eye-box) in one or two dimensions, thus enabling some movement of the eye/s (or other viewing system) to occur, whilst still enabling the viewing system to see the holographic reconstruction even with a very small display device/hologram. As explained in British patent application GB2302916.8 filed on 28 Feb. 2023, such an arrangement may allow for a good quality virtual image of the holographic reconstruction per se (when focusing at the virtual image distance). However, the viewing experience may be adversely affected by the fact that the viewer is required to look through or past the image of the hologram/display device to view the virtual image of the holographic reconstruction.

In GB2302916.8 (filed on 28 Feb. 2023), the applicant disclosed an optical system to address the above problem. Said optical system comprises a display device arranged to spatially modulate light in accordance with a hologram displayed thereon and to form a holographic wavefront which forms a holographic reconstruction of an image downstream of the display device. The optical system further comprises an optical component (e.g. lens) arranged to form: a) a virtual image of the holographic reconstruction; and b) an image of the displayed hologram/display device. The optical component is arranged such that a magnitude of the separation of the virtual image of the holographic reconstruction and the image of the displayed hologram/display device is greater than a virtual image distance of the virtual image of the holographic reconstruction. As such, the image of the displayed hologram/display device is far removed from the virtual image of the holographic reconstruction. In some examples, a virtual image of the display device is formed at infinity such that the effective distance between the virtual image of the display device and the virtual image of the holographic reconstruction (which is at a finite image distance) is infinite. In other examples, a real image of the display device is formed downstream of the optical component, again far removed from the virtual image of the holographic reconstruction (which will be upstream of the optical component). Arranging the optical component in this way advantageously significantly reduces the impact of the virtual surface from obstructing/distracting a viewer at the viewing window. In particular, the optical component can be arranged to either form the image of the hologram/display device at infinity (far beyond the virtual image of the holographic reconstruction) or at a position downstream of the optical component (typically behind the viewing system). In either set of examples, the viewer is not required to look through or past the image of the hologram/display device to view the virtual image of the holographic reconstruction when the optical component is arranged in this way.

The above optical system requires a holographic reconstruction (or relayed holographic reconstruction) to be formed within a focal length of a lens of the optical system positioned between the holographic reconstruction and the waveguide. Meanwhile, the display device (or relayed display device) should be positioned at or (just) beyond the focal length of said lens so that, respectively, either a virtual image is formed at infinity or real image is formed downstream of the waveguide. Conventionally, a distance between the display device and a holographic reconstruction formed by the display device may be relatively large (for example, several metres). Thus, to achieve said arrangement, and to do so in a way in which the virtual image of holographic reconstruction is formed at a desired virtual image distance (e.g. at about 10 metres), the optical system may need to comprise a relatively very long optical axis and/or a lens having a relatively very long focal length. This goes against a general requirement for compactness. For example, the optical system may be for a head-up display for a vehicle which generally has strict requirements for the packaging size. Furthermore, an arrangement having a very long optical axis and/or a lens having a relatively very long focal length may result in a relatively high proportion of light to be lost from the system. These problems can be solved by providing an optical system which is arranged to display a hologram that forms a holographic reconstruction relatively close to the display device (and downstream of the display device). This allows for a compact optical system/head-up display comprising the optical system. As described in British patent application GB2304312.8 filed on 24 Mar. 2023, the applicant has previously proposed that one way in which the holographic reconstruction could be formed relatively close to the display device is (in a point cloud-type hologram) using a relatively very small group of display device pixels to form each image point of the holographic reconstruction. For example, contiguous group of pixels comprising less than 100,000 pixels, optionally less than 25,000 pixels, optionally less than 5,000 pixels, optionally less than 1,000 pixels, optionally less than 500 pixels, optionally less than 200 pixels, optionally less than 100 pixels may be used to form the holographic reconstruction relatively very close to the display device.

After thorough simulation and experimentation, the inventors have found that the above described optical systems allows for the optical system to be made compact (using a relatively small number of pixels to form a holographic reconstruction relatively close to the display device) while maintaining a good quality holographic reconstruction and without a viewer being required to look through or past the image of the hologram/display device to view the virtual image of the holographic reconstruction. However, the inventors have also unexpectedly found additional artifacts/noise may be apparent to a viewer when the holographic reconstruction is formed relatively close to the display device compared to more conventional optical systems (when the holographic reconstruction may be formed at least 1 metre away from the display device, for example, and when a large proportion/substantially all pixels of the display device contribute to each image point of the holographic reconstruction). Said artifacts/noise takes the form of unexpectedly light areas adjacent to areas of the holographic reconstruction comprising content. These artifacts have a shape that corresponds to the shape of the adjacent content area of the holographic reconstruction. The inventors have found that these artifacts have a particularly high intensity along a boundary of the artifact that is furthest from the respective/adjacent content area. The result of this is that the artifacts/noise may appear as a “halo” around or adjacent to content areas of the holographic reconstruction. As such, this noise may be referred to as a “halo”, contributing to a “halo effect”, throughout this disclosure. The inventors have found that this halo adversely affects the viewing experience of a viewer viewing a virtual image of the holographic reconstruction because unintentional (halo) artifacts are present in the holographic reconstruction (that are not present in the picture encoded in the hologram and were not apparent in other, more conventional, holographic projection arrangements—at least to the naked eye).

The inventors have found that the halo effect is caused by scattering of light when the display device (displaying the hologram) is illuminated. In some examples, the display device is a pixelated display device such as a (liquid crystal on silicon) spatial light modulator. The inventors have found that light may be scattered off at least some pixels of the display device to form the halo effect. For example, in a point-cloud type hologram, the hologram may be calculated such that groups of pixels on the display device form each image point of the holographic reconstruction (the image points being in content areas of the holographic reconstruction). Display device pixels may contribute to multiple image points. Ideally, light illuminating the display device would be diffracted so as to contribute only to intended image points of the holographic reconstruction. However, in reality, some light may be scattered. This scattering may be caused by, for example, the birefringence of the display device and/or imperfections in the hologram calculation or the ability of the display device to completely accurately display the hologram/spatially modulate light in accordance with the hologram. Thus, some light illuminating a group of pixels of the display device may be scattered and may not contribute to the intended image points of the holographic reconstruction and instead may contribute to/form artifacts in the holographic reconstruction of the picture (not present in the picture encoded in the displayed hologram)—e.g. a halo.

The inventors have found that the proportion of light that is scattered may be greatest when there is a sudden change in a phase delay applied by adjacent pixels of the display device. When the hologram is calculated such that a relatively small number of display device pixels contribute to each image point of the holographic reconstruction, there may be areas of the display device encoded with a hologram which contribute to content areas of the holographic reconstruction. These areas may be referred to herein as diffractive areas or diffractive content. There may also be areas of the display device that are “empty” (i.e. do not contain diffractive content, e.g. have a constant phase value such as 0 or 2π). These “empty” areas may be referred to herein as non-diffractive areas or non-diffractive content herein. At the boundary between the diffractive content and the non-diffractive content may be a very sudden change in phase delay. Thus, scattering may be particularly noticeable when there are non-diffractive content areas of the hologram/on the display device (with pixels close to boundary between the diffractive areas and the non-diffractive areas of the display device/hologram contributing a high proportion of the scattered light). Furthermore, scattering from the pixels close to the boundary between the hologram encoded areas and the empty areas of the display device scatter a high proportion of the light that is incident on those pixels because these pixels only contribute to image pixels over a small angle, rather than the full diffraction of the display device. Again, this means that pixels close to the boundary scatter a high proportion of the light incident thereon. Both of these effects mean that the halo effect is particularly noticeable/apparent in the unconventional/unusual optical system in which very few pixels contribute to each image point. In more conventional systems, in which a very large number of pixels contribute to each image point, the ratio of scattered light to light used to form image points may be much lower and so the halo effect may be much less apparent (and may not be visible at all to the naked eye). Furthermore, such more “conventional” systems do not generally comprise empty or non-diffractive areas on the display device/hologram. Furthermore, after simulation and experimentation, the inventors have found that the size of the “halo” depends on the diffraction angle and the distance between the display device and the holographic reconstruction. The greater the distance, the larger the halo and so the more the scattered light is spread out. Thus, in more conventional holographic optical systems, the halo may be spread over a relatively large area such that the intensity of the halo is effectively negligible and the halo is not apparent. Furthermore, there is a greater chance that a halo associated with a content area of the holographic reconstruction may overlap with another content area of the and so may be hidden by said other content area. However, when the holographic reconstruction is formed relatively close to the display device, the halo may form relatively closely to the perimeter of content areas of the holographic reconstruction and be relatively much more intense. Furthermore, there is a much higher chance that the halo will not overlap with other content areas. In summary, the inventors have identified a halo effect which adversely affects the viewing experience when an optical system is arranged to form a holographic reconstruction relatively close to the display device. This halo effect has not typically previously been a problem (or even apparent) in more conventional optical systems for holographic projection.

Having identified the problem of the halo effect, the inventors have recognised that there is a need to remove or reduce it. One option could be a hardware solution to block or deflect the scattered light (forming the halo effect) from reaching a viewing window of the optical system/light engine. However, a hardware solution would add complexity and cost. Instead, the inventors have developed a software solution to the problem (which does not add complexity or cost to the overall optical system).

As above, the inventors have found that the halo effect is predominantly caused when there is a sudden/relatively large step-change in phase delay applied by adjacent pixels of the display device (such as may exist at a border between diffractive and non-diffractive areas when the hologram is displayed on the display device). The inventors have thus recognised that the halo effect can be (significantly) reduced by reducing the size of these changes in phase delay. In particular, the inventors have recognised that the above described hologram blurring function can be applied at the or each boundary between diffractive and non-diffractive area of a hologram to blur or smooth pixel values at said boundaries (at the expense of losing some (accurate) phase information from the hologram). After thorough simulation and experimentation, the inventors have found that this blurring or smoothing can be applied without a significant reduction in the apparent quality of holographic reconstructions formed using the hologram (despite the loss of phase information).

In a first aspect, there is provided a light engine. The light engine comprises a display device comprising an array of pixels. Each pixel of the display device is for applying a phase delay to light incident thereon. For example each pixel of the display device may be (individually) controllable to apply a desired phase delay. Each pixel of the display device may be arranged to be controllable to apply one of a plurality of discrete phase delays based on the phase value of the hologram pixel so as to represent, or display, the hologram.

The light engine is configured to receive a hologram of a picture. The hologram comprises an array of pixel values. Each pixel value may be or represent a phase delay. For example, each pixel value of the hologram may have or correspond to a phase delay for a pixel of the display device. The display device may be arranged to display the hologram. In this case, the array of pixels of the display device may be controlled to apply a phase delay quantified by the respective phase delay value of a corresponding hologram pixel. The hologram comprises a first area and a second area. The first area comprises or consists of diffractive content. The second area comprises or consists of non-diffractive content. The first area is adjacent to the second area.

The light engine is further configured to apply a hologram blurring function to the hologram. The light engine is configured to apply the hologram blurring function in a boundary area of the first and second areas. The boundary area may comprise a border between the first area and the second area. The boundary area may overlap at least one of, optionally both of, a portion of the first area and a portion of the second area. The light engine may be configured to output a modified hologram (the modified hologram being the hologram after the hologram blurring function has been applied).

The hologram blurring function is arranged to change a gradient of the pixel values in (e.g. across) the boundary area of the modified hologram (relative to the un-modified hologram initially received by the light engine).

The first area may comprise a contiguous group of pixel values. When the hologram is displayed on the display device, a contiguous group of display device pixels may display the first area. The first area (comprising or consisting of diffractive content) may be referred to as a (first) diffractive content area or a (first) diffractive area. As used herein, the first area comprising “diffractive content” means that the pixel (phase) values in the first area are spatially varying. In other words, adjacent pixel values or adjacent groups of pixel values within the first area may be different. Thus, when the hologram is displayed on a display device, light incident on areas of the display device encoded with diffractive content (e.g. the first area) may diffract said incident light. For example, said incident light may be spatially modulated in accordance with the diffractive content and may form a holographic wavefront which forms a holographic reconstruction of a picture.

The second area may comprise a contiguous group of pixel values. When the hologram is displayed on the display device, a contiguous group of display device pixels may display the second area. The second area may be referred to as a (first) non-diffractive content area or (first) non-diffractive area. As used herein, the second area comprising “non-diffractive content” means that the pixel (phase) values in the second area do not spatially vary (within the second area). In other words, each pixel value in the second area of the hologram may be substantially the same or constant. In one example, each pixel value may be zero. In another example, each pixel value may be 2π. Thus, when the hologram is displayed on a display device, light incident on areas of the display device encoded with non-diffractive content (e.g. the second area) may not diffract said incident light.

As used herein, the “hologram blurring function” is a function that is suitable for applying to the hologram to change a gradient of pixel values. For example, the hologram blurring function may be applied to one or more pixels of the hologram. The hologram blurring function, applied to one pixel of the hologram, may change that pixel based on a plurality or group of pixels. The change in the gradient of pixel values (applied by the hologram blurring function) may smooth or blur the pixel values. The hologram blurring function may change a gradient of the pixel values such that the pixel values change progressively (e.g. progressively increase or progressively decrease) in a substantially continuous manner (in the boundary area). This may reduce the magnitude/size of individual changes in value (phase) of adjacent pixels (in the boundary area). Thus, the application of the hologram blurring function may substantially reduce a halo effect attributable to the pixels over which the hologram blurring function has been applied. In other words, a pixel value change associated with the boundary of the modified hologram is greater than that of the corresponding boundary of the original hologram.

In some embodiments, the hologram comprises a plurality of pairs of adjacent pixel values. The plurality of pairs of adjacent pixel values may each be at or along a border between the first area and the second area. Each pair of pixel values may comprise a first pixel value and a second pixel value. The first pixel value may be a value of the first area. The second pixel value may be a value of the second area. The light engine may be arranged to apply the hologram blurring function to the hologram for at least one pixel value of each pixel pair. In some embodiments, for each pair of pixels, the hologram blurring function may be arranged to reduce a difference between the first pixel value and the second pixel value of the respective pair of pixels. The reduction may be such that the difference in pixel values is reduced in the modified hologram compared to a difference in the first and second pixels values in the absence of the hologram blurring function (i.e. in the initially received hologram).

In some embodiments, substantially all of the boundary area may overlap with the first area or the second area. In other words, any arbitrary portion of the boundary area may overlap with at least one of the first area or the second area. As above, the boundary area is the area of the hologram in which the hologram blurring function is applied. So, the boundary of the hologram is the area in which the (gradient of) pixel values are changed. Thus, pixel values in portions of first area overlapped by the boundary area may be changed by the hologram blurring function. Similarly, pixel values in portions of the second area overlapped by the boundary area may be changed by the hologram blurring function. The inventors have found that it may be advantageous for the hologram blurring function to change values in both the first and second areas (to reduce the number of phase values changed in any one area and so potentially reducing the amount of information lost in any one area). In some embodiments, at least 25 percent of the boundary area may overlap with the first area. In some embodiments, at least 25 percent of the boundary area may overlap with the second area. In some embodiments, the boundary area may be substantially centred on the boundary between the first area and the second area (in the received hologram). Thus, substantially 50 percent of the boundary area may overlap with the first area and substantially 50 percent of the boundary area may overlap with the second area.

In some embodiments, the boundary area comprises a first edge. The first edge may be disposed, fall or located within the first area. The boundary area may comprise a second edge. As such, at least a portion of the boundary area may overlap with the first area (e.g. a portion of the boundary area extending between the first edge and the border between the first area and the second area). The second edge may be opposite to the first edge. The second edge may be disposed, fall or located within the second area. As such, at least a portion of the boundary area may overlap with the second area (e.g. a portion of the boundary area extending between the second edge and the border between the first area and the second area).

In some embodiments, the hologram blurring function is arranged such that the pixel values of the boundary area in the modified hologram progressively changes with distance from the second edge (after the hologram blurring function has been applied). For example, the hologram blurring function may be arranged such that the value of pixels of the boundary area in the modified hologram progressively increases or decreases with distance from the second edge.

In some embodiments, the hologram blurring function is arranged such that the change of pixel values of the boundary area in the modified hologram has a substantially gaussian shape from the second side to the first side (or vice versa).

The inventors have found that the greater the number of pixel values over which the hologram blurring function is applied, the greater the reduction in the halo effect. However, increasing the number of pixel values over which the hologram blurring function is applied also increases the number of pixel values that are changed and so increases the amount of phase information that is lost in the modified hologram (relative to the un-modified/un-processed hologram). The inventors have recognised that the size of the boundary area needs to be selected to balance these two effects (such that the halo effect is satisfactorily reduced without significant image quality deterioration in the holographic reconstruction as a result of loss of phase information). In some embodiments, a thickness of the boundary area is defined as the distance between the first edge and the second edge. In some embodiments, the thickness of the boundary area is 20% or less, optionally 10% or less, optionally 5% or less than a width of (a display area of) the display device. In some embodiments, the thickness of the boundary area is 1% or greater, optionally 5% or greater than a width of (a display area of) the display device. In some embodiments, the thickness of the boundary area is 5 pixels or greater, optionally 10 pixels or greater, optionally 50 pixels or greater. In some embodiments, the thickness of the boundary area is 1000 pixels or less, optionally 500 pixels or less, optionally 200 pixels or less. The inventors have found that such thicknesses provide a good balance between halo reduction while maintaining image quality.

In some embodiments, the light engine being arranged to apply the hologram blurring function comprises the light engine being arranged to detect a border between the first area and the second area. In some embodiments, the light engine is arranged to detect the border using algorithmic means, as will be apparent to the skilled reader. In some embodiments, the light engine is arranged to detect the border based on the pixel values of the hologram.

In some embodiments, the light engine may be arranged to apply a binary filter or two-value filter to the hologram. The light engine may be arranged to apply the binary filter or two-value filter to the hologram as part of the process of border detection. The light engine may be arranged to detect the border based on pixel values after the binary filter or two-value filter has been applied to the hologram (i.e. based on pixel values of the binary hologram). In some embodiments, the light engine may be arranged to output a binary hologram in which each pixel value of the (original) hologram has been replaced with either a first value or a second value, based on the respective (original) pixel value. Thus, the binary hologram may consist of pixel values having the first value or the second value (only).

In some embodiments, the light engine may be arranged to apply the binary filter to each pixel value of the hologram. The binary filter is arranged to take as an input a pixel value of the hologram and compare that pixel value to a predetermined value. The predetermined value may be an (expected) value of each of the pixel values in the non-diffractive content area of the hologram. For example, if each of the pixel values in the non-diffractive content area of the hologram is zero, then the predetermined value of the binary filter may be zero also. The binary filter may be arranged to output the first value if the respective pixel value is not equal to the predetermined value and output a second value if the respective pixel value is equal to the predetermined value. In some embodiments, the first value is 1 and the second value is zero. However, this is merely exemplary. It should be clear to the skilled person that the first value and second value can take any value, provided the first and second values are different to one another.

In some embodiments, the light engine is arranged to detect the border based on when a change or derivative of adjacent pixel values of the binary hologram exceeds a (predetermined) threshold. Generally, in the binary hologram, each pixel value in a first area corresponding to the first area of the original hologram (comprising diffractive content) will have one of the first value or second values and each pixel value in a second area corresponding to the second area of the original hologram (comprising non-diffractive content) will have the other of the first or second values. Thus, the change or derivative of adjacent pixel values of the binary hologram may be substantially zero within one of the first or second area. Only at the border between the first and second area (where adjacent pixel values will change from the first value to the second value, or vice versa) will the change or derivative of adjacent pixel values be greater than zero. Thus, the change or derivative of adjacent pixel values of the binary hologram may only be non-zero at the border. Therefore, the light engine may advantageously detect/determine the location of the border based on when a change or derivative of adjacent pixels values exceeds a threshold, the threshold being zero.

In particular, after receiving the hologram (comprising the first and second area), the light engine may be arranged to detect the border in the received hologram. The light engine may be arranged to detect the border so as to determine the area in which to apply the hologram blurring function. The light engine being arranged to detect the border (rather than relying on a predetermined border location, for example) may be advantageous because it means that the light engine may apply the hologram blurring function to any shape or form of first/second area of the hologram. For example, the light engine may be arranged to display a sequence of different holograms on the display device. Each hologram of the sequence of holograms may be comprise a different first area and second area. For example, the position and shape of the first area and second area may be different for each hologram. Thus, the border between the first area and the second area may change for each hologram in the sequence. The light engine being arranged to detect the border means that the light engine can actively determine the border (and the associated boundary area) for each hologram, without needing to receive positional information of the border.

In some embodiments, the hologram blurring function is arranged to output a mean average value of neighbouring pixel values for each pixel value that the hologram blurring function is applied to. For example, the hologram blurring function may be applied to a first pixel value of the boundary area. Thus, the hologram blurring function may be arranged to receive the first pixel value as an input. The hologram blurring function may be arranged to look-up or otherwise determine neighbouring pixel values to the first pixel value, for example a two-dimensional array of pixel values neighbouring the first pixel. The hologram blurring function may be arranged to determine the mean average of said pixel values (including both the first pixel value and the neighbouring pixel values). The hologram blurring function may be further arranged to output the mean average pixel value. The output of the hologram blurring function may replace the first pixel value in the modified hologram. This process may be repeated for each pixel in the boundary area.

In some embodiments, the hologram blurring function is a spatial filter such as a box blur filter. In some embodiments, the hologram blurring function comprises a kernel, such as a two-dimensional kernel. In some embodiments, a width and/or a depth of the kernel is substantially equal to the thickness of the boundary area (in pixels). The width and/or depth of the kernel may refer to a width or depth of the kernel along a first or second dimension, respectively of the kernel. The thickness may be refer to a number of elements or pixels of the kernel extending in the first or second dimension. The width or depth of the kernel being substantially equal to the thickness of the boundary area may mean that the number of elements or pixels in the respective dimension of the kernel is equal to the thickness of the boundary area in pixels.

In some embodiments, the light engine being arranged to apply the hologram blurring function comprises applying the function to each pixel value of the border. In some embodiments, the boundary area of the modified hologram comprises mean average pixel values calculated using the hologram blurring function.

In some embodiments, the hologram is arranged such that a distance between the display device and a holographic reconstruction of the hologram (closest to the display device) is relatively short. This distance may be defined in the absence of any physical optical component between the display device and said holographic reconstruction. For example, said distance may be 50 millimetres or less, optionally 20 millimetres or less, optionally 10 millimetres or less. Optionally, said distance may be between 1 millimetre and 20 millimetres. As described above, the inventors have found that the halo effect may be particularly apparent when there are such relatively short distances between the display device and said holographic reconstruction (and it is very unconventional to arranged to the hologram to form a reconstruction at such a short distance).

In some embodiments, the light engine may be arranged to form a relayed holographic reconstruction. This relayed holographic reconstruction may be formed further downstream of the display device. The relayed holographic reconstruction may effectively be an image of the holographic reconstruction formed relatively close to the display device. For example, some embodiments of the light engine further comprise an optical relay. The optical relay may be positioned downstream of the display device. The optical relay may comprise two lenses arranged in cooperation to form the relayed holographic reconstruction. The optical relay may be further arranged to form a relayed display device (which may be an image of the display device). In such cases, the distance between the relayed display device and the (relayed) first holographic reconstruction may be 50 millimetres or less, optionally 20 millimetres or less, optionally 10 millimetres or less. Optionally, said distance may be between 1 millimetre and 20 millimetres.

In some embodiments, the holographic reconstruction comprises a plurality of image points. In some embodiments, the hologram is arranged such that each image point of the holographic reconstruction is formed using a contiguous group of pixels of the display device. Each contiguous group of pixels may comprise less than 10% of a total number of pixels of the display device. Each contiguous group of pixels may comprise less than 5% of the total number of pixels of the display device. Each contiguous group of pixels may comprise less than 100,000 pixels, optionally less than 25,000 pixels, optionally less than 1,000 pixels, optionally less than 100 pixels. This may result in the holographic reconstruction being formed a relatively short distance from the display device/relayed display device (said short distances being defined above).

As above, the hologram displayed on the display device is a hologram of a picture. In some embodiments, the picture comprises picture content in a first content area. As such, the holographic reconstruction may comprise corresponding picture content in a first content area. The first area of the hologram (comprising diffractive content) may be arranged to form the picture content in the first content area.

In some embodiments, the picture/holographic reconstruction comprises a plurality of content areas. Each content area may comprise picture content.

In some embodiments, the hologram may comprise a plurality of different first areas and a plurality of different second areas. There may be a plurality of borders between the plurality of first areas and second areas. There may be one or more boundary areas. Each of the plurality of borders may be contained in the one or more boundary areas. The light engine may be configured to apply the hologram blurring function to the hologram in each of the one or more boundary areas. The hologram blurring function may thus change a gradient of the pixel values in the or each boundary areas. This may smooth or blur the pixel (phase) values of the hologram at each boundary/border between first areas and second areas to reduce the magnitude of differences between adjacent pixel values at the border to reduce the so-called halo effect. In other words, in more complex holograms comprising multiple borders may be detected between a plurality of first and second areas. In the absence of the hologram blurring function, relatively large changes in pixel (phase) value may exist at these borders which may contribute to the halo effect. By applying the hologram blurring function, the halo effect can be substantially reduced, even for more complex holograms.

In some embodiments, the hologram is arranged such that each image point of the holographic reconstruction is formed using a contiguous group of pixels of the display device. Each contiguous group of pixels may comprise less than 10% of a total number of pixels of the display device. Each contiguous group of pixels may comprise less than 5% of the total number of pixels of the display device. Each contiguous group of pixels may comprise less than 100,000 pixels, optionally less than 25,000 pixels, optionally less than 1,000 pixels, optionally less than 100 pixels. This may result in the holographic reconstruction being formed a relatively short distance from the display device/relayed display device (said short distances being defined above).

In some embodiments, the light engine may further comprise a waveguide. The waveguide may be arranged to waveguide the received holographic wavefront between a pair of reflective surfaces thereof, wherein one surface of the pair of reflective surfaces is partially transmissive such that a plurality of replicas of the holographic wavefront are emitted therefrom.

In some embodiments, the light engine may further comprise an optical component. The optical component may be positioned between the holographic reconstruction and the waveguide. The optical component may be arranged to form a virtual image of the holographic reconstruction upstream of the display device.

In some embodiments, the light engine further comprises an optical relay between the display device and waveguide, the optical relay comprising two lens arranged in cooperation to form a relayed holographic reconstruction. The relayed holographic reconstruction may be an image of the holographic reconstruction formed by the hologram displayed on the display device. A distance between the relayed holographic reconstruction and the optical component may be less than a focal length of the optical component such that the virtual image of the holographic reconstruction formed by the optical component is a virtual image of the relayed holographic reconstruction.

In some embodiments, the optical component is arranged such that the holographic wavefront coupled into the waveguide is a transform of a holographic wavefront encoding the picture, optionally a Fourier transform of the hologram or holographic wavefront.

In a second aspect, there is provided a head-up display for a vehicle comprising the light engine of the previous aspect.

In a third aspect, there is provided a method of processing a hologram. In some embodiments, the method is a method of processing a boundary area of the hologram. In some embodiments, the method is a method of processing the hologram to blur or smooth the hologram in the boundary area.

The method comprises receiving a hologram of a picture. The hologram comprises an array of pixels values. In some embodiments, each pixel value is or corresponds to a phase delay value. This phase delay value may be used to control a phase delay of a pixel of a display device such as a spatial light modulator. The hologram comprises a first area comprising or consisting of diffractive content. The hologram comprises a second area comprising or consisting of non-diffractive content. The first area is adjacent to the second area.

The method further comprises applying a hologram blurring function to the hologram in a boundary area of the first and second areas to output a modified hologram. In embodiments, the boundary area comprises a border between the hologram area and the empty area. In embodiments, the boundary area overlaps at least one of, optionally both of, a portion of the first area and a portion of the second area. The hologram blurring function is arranged to change a gradient of the pixel values in the boundary area.

In a fourth aspect, there is provided a diffractive structure or hologram. The diffractive structure or hologram may be referred to as a “blurred” or “processed” diffractive structure or hologram. Herein, a diffractive structure will be described. But it should be clear that references to diffractive structure could be replaced with “hologram”.

The diffractive structure comprises an array of pixel values. The diffractive structure is arranged to spatially modulate light to form a holographic wavefront. The holographic wavefront is arranged to form a holographic reconstruction of a picture that is encoded in the diffractive structure. The diffractive structure comprises a first area comprising diffractive content and a second area comprising non-diffractive content. The diffractive structure further comprises a boundary area between the first area and the second area. In embodiments, the boundary area of the hologram is an area in which the hologram has been blurred. In particular, the boundary area of the hologram may be an area in which a hologram blurring function has been applied to the hologram to reduce differences in the pixel values between adjacent pixels. The boundary area comprises a first edge adjacent to the first area and a second edge opposite to the first edge and adjacent to the second area. The diffractive structure is arranged such that pixel values in the boundary area progressively change (such as progressively increase or decrease) with distance from the second edge.

In the present disclosure, the term “replica” is merely used to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. It may therefore be said that a plurality of replicas of the hologram are formed. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances—providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8, and cross-sections of the corresponding hologram channels, H1-H8;

FIG. 3 shows a hologram displayed on an LCOS that directs light into a plurality of discrete areas;

FIG. 4 shows a system, including a display device that displays a hologram that has been calculated as illustrated in FIGS. 2 and 3;

FIG. 5A shows a perspective view of a first example two-dimensional pupil expander comprising two replicators each comprising pairs of stacked surfaces;

FIG. 5B shows a perspective view of a first example two-dimensional pupil expander comprising two replicators each in the form of a solid waveguide;

FIG. 6 is a cross-sectional schematic view of the optical components of an optical system;

FIG. 7 is a cross-sectional schematic view of the optical components of another optical system, the optical system comprising an optical relay and being arranged to form a virtual image of a relayed hologram at infinity;

FIG. 8 shows a cross-sectional schematic ray diagram showing features of the optical system of FIG. 7;

FIG. 9 is a cross-sectional schematic view of the optical components of yet another optical system, the optical system comprising an optical relay and being arranged to form a real image of a relayed hologram;

FIG. 10 shows a cross-sectional schematic ray diagram showing features of the optical system of FIG. 9;

FIG. 11 shows a cross-sectional schematic view of a portion of a pixelated display device forming a holographic reconstruction comprising a plurality of image points;

FIG. 12A shows a schematic view of a holographic reconstruction of a first picture consisting of a first content area;

FIG. 12B shows a schematic view of a holographic reconstruction of a second picture comprising a plurality of content areas and non-content areas;

FIG. 13 schematically represents an array of phase values of a hologram;

FIG. 14 schematically represents an array of values of a binary hologram, calculated by applying a binary filter to the hologram of FIG. 13 and including a detected border; and

FIG. 15 shows the hologram of FIG. 13 with the detected border of FIG. 14 applied and with a boundary area comprising that detected border, FIG. 15 also represents the process of applying a hologram blurring function to phase values in the boundary area of the hologram.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

### Conventional Optical Configuration for Holographic Projection

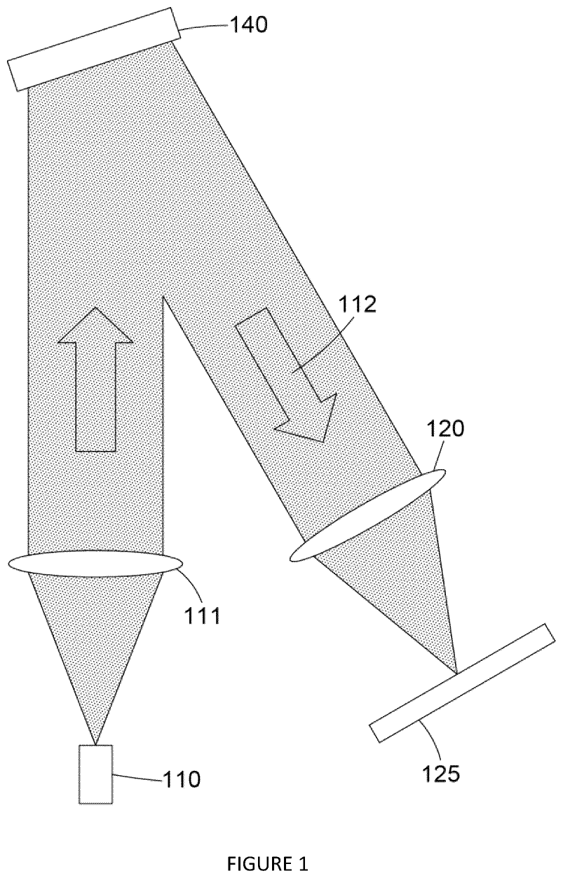

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture, of the present disclosure, and is used exclude light paths from the hologram calculation. British patent application 2112213.0, filed 26 Aug. 2021 and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 and also incorporated herein by reference, discloses a third method of calculating a hologram which includes a step of determining a region of a so-called extended modulator formed by a hologram replicator. The region of the extended modulator is also an aperture in accordance with this disclosure.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Large Field of View Using Small Display Device

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two—orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments—described only by way of example of a diffracted or holographic light field in accordance with this disclosure—a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Channeling

The hologram formed in accordance with some embodiments, angularly-divides the image content to provide a plurality of hologram channels which may have a cross-sectional shape defined by an aperture of the optical system. The hologram is calculated to provide this channeling of the diffracted light field. In some embodiments, this is achieved during hologram calculation by considering an aperture (virtual or real) of the optical system, as described above.

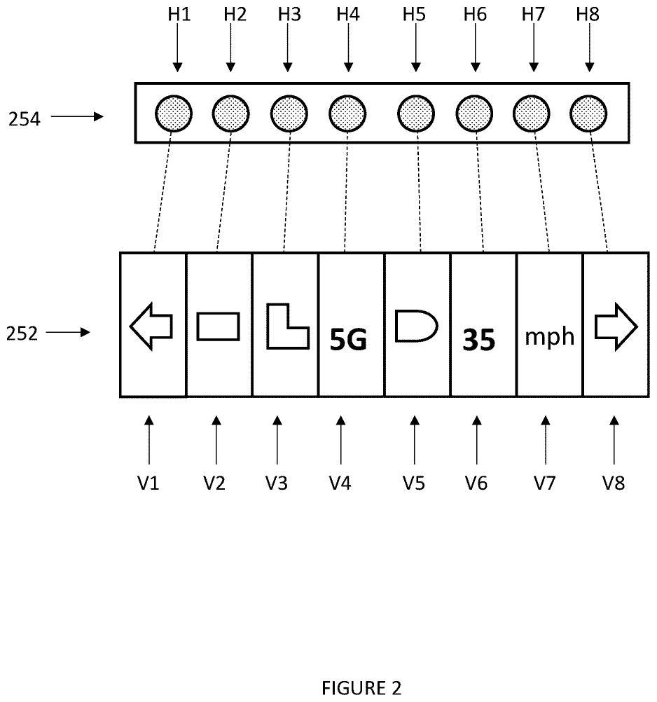

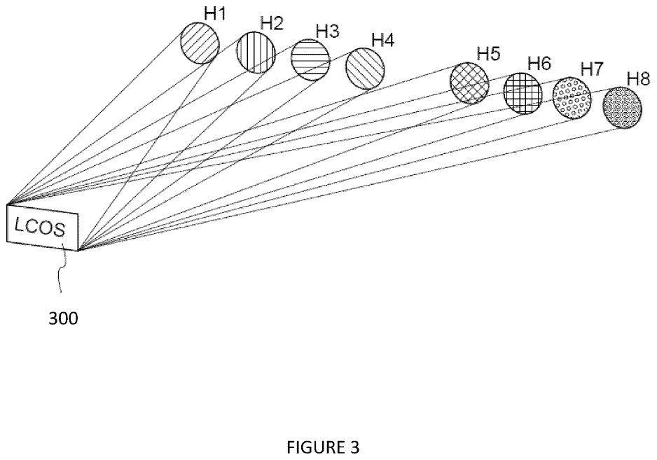

FIGS. 2 and 3 show an example of this type of hologram that may be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channeling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of an aperture of the optical system such as the entrance pupil of the viewing system.

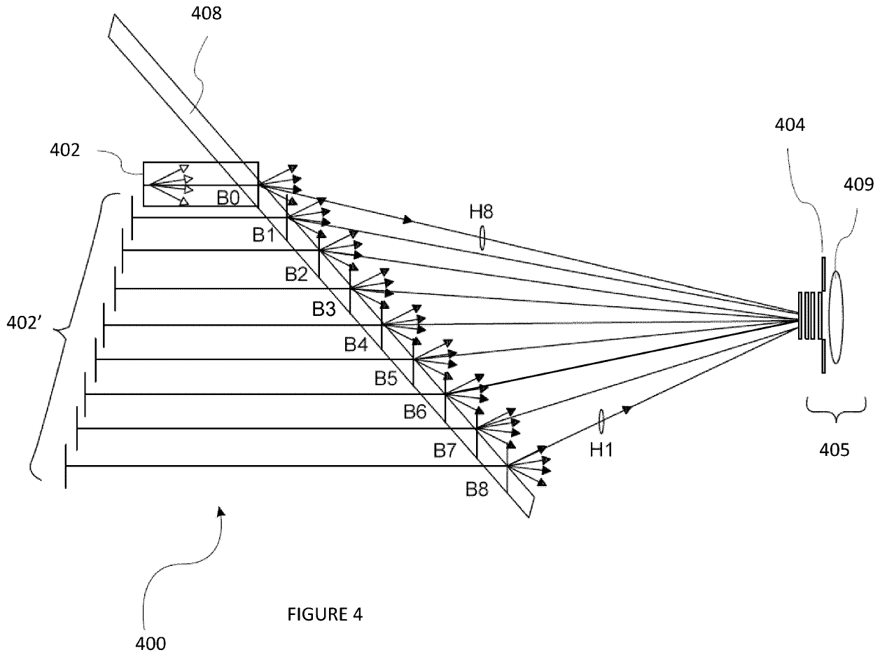

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

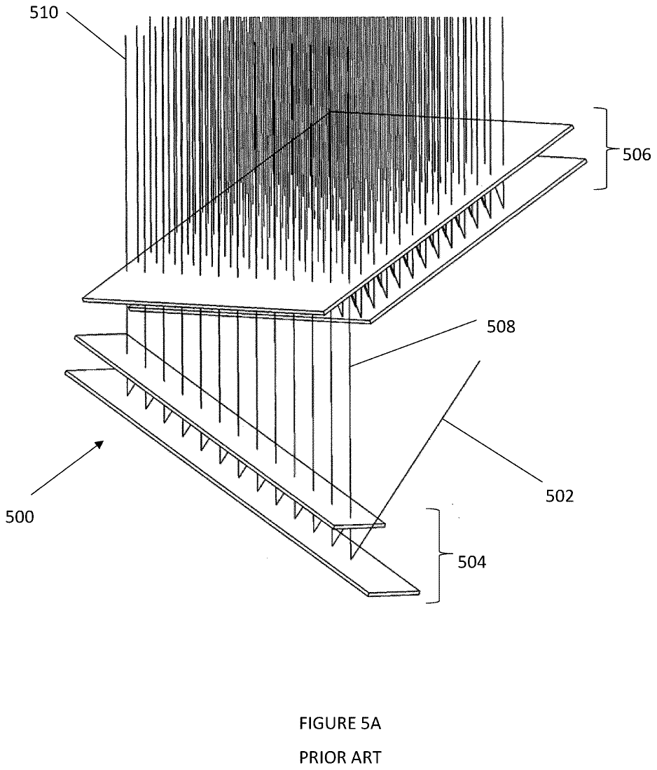

The waveguide 408 forms a plurality of replicas of the hologram, at the respective “bounce” points B1 to B8 along its length, corresponding to the direction of pupil expansion. As shown in FIG. 5, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide. Thus, the light of the expanded exit pupil may be considered to originate from a virtual surface (also called an “extended modulator” herein) comprising the display device 402 and the replica display devices 402′.

Although virtual images, which require the eye to transform received modulated light in order to form a perceived image, have generally been discussed herein, the methods and arrangements described herein can be applied to real images.

### Two-Dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

FIG. 5A shows a perspective view of a system 500 comprising two replicators, 504, 506 arranged for expanding a light beam 502 in two dimensions.

In the system 500 of FIG. 5A, the first replicator 504 comprises a first pair of surfaces, stacked parallel to one another, and arranged to provide replication—or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5A), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication—or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5A), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5A combine to provide a two-dimensional replicator (or, “two-dimensional pupil expander”). Thus, the replica light beams 510 may be emitted along an optical path to an expanded eye-box of a display system, such as a head-up display.

In the system of FIG. 5A, the first replicator 504 is a waveguide comprising a pair of elongate rectilinear reflective surfaces, stacked parallel to one another, and, similarly, the second replicator 504 is a waveguide comprising a pair of rectangular reflective surfaces, stacked parallel to one another. In other systems, the first replicator may be a solid elongate rectilinear waveguide and the second replicator may be a solid planar rectangular shaped waveguide, wherein each waveguide comprises an optically transparent solid material such as glass. In this case, the pair of parallel reflective surfaces are formed by a pair of opposed major sidewalls optionally comprising respective reflective and reflective-transmissive surface coatings, familiar to the skilled reader.

FIG. 5B shows a perspective view of a system 500 comprising two replicators, 520, 540 arranged for replicating a light beam 522 in two dimensions, in which the first replicator is a solid elongated waveguide 520 and the second replicator is a solid planar waveguide 540.

In the system of FIG. 5B, the first replicator/waveguide 520 is arranged so that its pair of elongate parallel reflective surfaces 524a, 524b are perpendicular to the plane of the second replicator/waveguide 540. Accordingly, the system comprises an optical coupler arranged to couple light from an output port of first replicator 520 into an input port of the second replicator 540. In the illustrated arrangement, the optical coupler is a planar/fold mirror 530 arranged to fold or turn the optical path of light to achieve the required optical coupling from the first replicator to the second replicator. As shown in FIG. 5B, the mirror 530 is arranged to receive light—comprising a one-dimensional array of replicas extending in the first dimension—from the output port/reflective-transmissive surface 524a of the first replicator/waveguide 520. The mirror 530 is tilted so as to redirect the received light onto an optical path to an input port in the (fully) reflective surface of second replicator 540 at an angle to provide waveguiding and replica formation, along its length in the second dimension. It will be appreciated that the mirror 530 is one example of an optical element that can redirect the light in the manner shown, and that one or more other elements may be used instead, to perform this task.

In the illustrated arrangement, the (partially) reflective-transmissive surface 524a of the first replicator 520 is adjacent the input port of the first replicator/waveguide 520 that receives input beam 522 at an angle to provide waveguiding and replica formation, along its length in the first dimension. Thus, the input port of first replicator/waveguide 520 is positioned at an input end thereof at the same surface as the reflective-transmissive surface 524a. The skilled reader will understand that the input port of the first replicator/waveguide 520 may be at any other suitable position.

Accordingly, the arrangement of FIG. 5B enables the first replicator 520 and the mirror 530 to be provided as part of a first relatively thin layer in a plane in the first and third dimensions (illustrated as an x-z plane). In particular, the size or “height” of a first planar layer—in which the first replicator 520 is located—in the second dimension (illustrated as the y dimension) is reduced. The mirror 530 is configured to direct the light away from a first layer/plane, in which the first replicator 520 is located (i.e. the “first planar layer”), and direct it towards a second layer/plane, located above and substantially parallel to the first layer/plane, in which the second replicator 540 is located (i.e. a “second planar layer”). Thus, the overall size or “height” of the system—comprising the first and second replicators 520, 540 and the mirror 530 located in the stacked first and second planar layers in the first and third dimensions (illustrated as an x-z plane)—in the second dimension (illustrated as the y dimension) is compact. The skilled reader will understand that many variations of the arrangement of FIG. 5B for implementing the present disclosure are possible and contemplated.

The image projector may be arranged to project a diverging or diffracted light field. In some embodiments, the light field is encoded with a hologram. In some embodiments, the diffracted light field comprises diverging ray bundles. In some embodiments, the image formed by the diffracted light field is a virtual image.

In some embodiments, the first pair of parallel/complementary surfaces are elongate or elongated surfaces, being relatively long along a first dimension and relatively short along a second dimension, for example being relatively short along each of two other dimensions, with each dimension being substantially orthogonal to each of the respective others. The process of reflection/transmission of the light between/from the first pair of parallel surfaces is arranged to cause the light to propagate within the first waveguide pupil expander, with the general direction of light propagation being in the direction along which the first waveguide pupil expander is relatively long (i.e., in its “elongate” direction).

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)—which, in practice, means a small display device (e.g. 1 cm). The inventors have addressed a problem of how to provide 2D pupil expansion with a diffracted light field e.g. diffracted light comprising diverging (not collimated) ray bundles.

In some embodiments, the display system comprises a display device—such as a pixelated display device, for example a spatial light modulator (SLM) or Liquid Crystal on Silicon (LCoS) SLM—which is arranged to provide or form the diffracted or diverging light. In such aspects, the aperture of the spatial light modulator (SLM) is a limiting aperture of the system. That is, the aperture of the spatial light modulator—more specifically, the size of the area delimiting the array of light modulating pixels comprised within the SLM—determines the size (e.g. spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extend by the use of at least one pupil expander.

The diffracted or diverging light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field—including some of, preferably most of, preferably all of, the replicas of the light field that are output by the first waveguide pupil expander—from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated and the second waveguide pupil expander may be substantially planar. The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

### Combiner Shape Compensation

An advantage of projecting a hologram to the eye-box is that optical compensation can be encoded in the hologram (see, for example, European patent 2936252 incorporated herein by herein). The present disclosure is compatible with holograms that compensate for the complex curvature of an optical combiner used as part of the projection system. In some embodiments, the optical combiner is the windscreen of a vehicle. Full details of this approach are provided in European patent 2936252 and are not repeated here because the detailed features of those systems and methods are not essential to the new teaching of this disclosure herein and are merely exemplary of configurations that benefit from the teachings of the present disclosure.

### Control Device

The present disclosure is also compatible with optical configurations that include a control device (e.g. light shuttering device) to control the delivery of light from a light channeling hologram to the viewer. The holographic projector may further comprise a control device arranged to control the delivery of angular channels to the eye-box position. British patent application 2108456.1, filed 14 Jun. 2021 and incorporated herein by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the deliver of hologram light channels, and their replicas, to the eye-box. Each aperture or window may comprise a plurality of liquid crystal cells or pixels.

### Image Formation

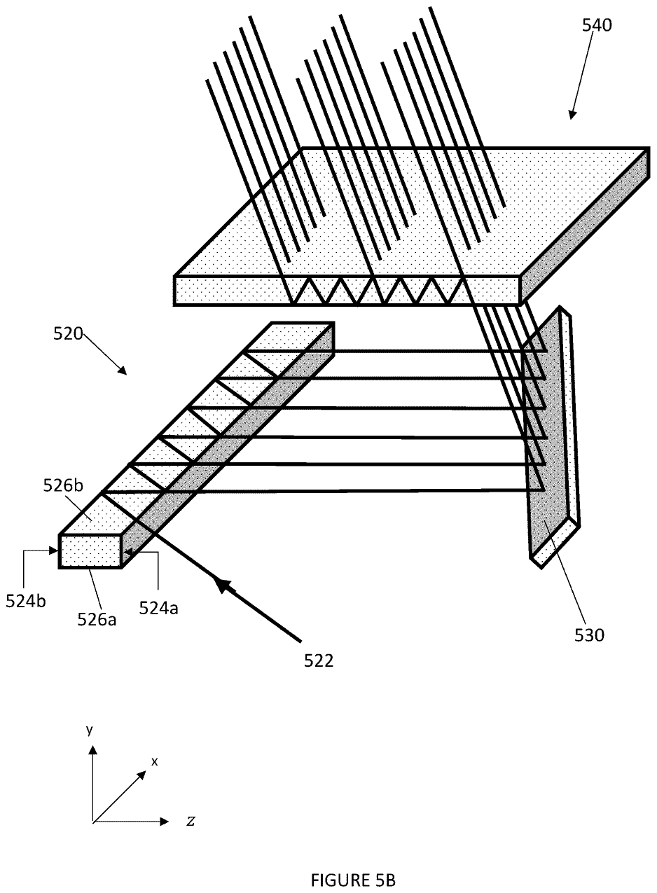

FIG. 6 is a cross-sectional schematic view of the optical components of an optical system 600 in which a relayed hologram is coupled into and replicated by a waveguide 611.

An optical axis of the optical system 600 is shown by dotted line 602 in FIG. 6. The optical system 600 comprises a display device 604 which, in this example, is a liquid crystal on silicon spatial light modulator. The display device 604 is arranged to display a hologram of a picture. Downstream of the display device 604 is an optical relay 606. The optical relay 606 comprises a first lens 608 and a second lens 610. The optical system 600 further comprises a waveguide 611 downstream of the second lens 610 of the optical relay 606. The waveguide 611 comprises a pair of opposing surfaces 622, 624 arranged to provide waveguiding of light therebetween in accordance with the previously described examples.

The first lens 608 of the optical relay 606 comprises a front focal plane 612 and a back focal plane 614. The front focal plane 612 is upstream of the first lens 608 and the back focal plane 614 is downstream of the first lens 608. The second lens 608 of the optical relay 606 comprises a front focal plane 616 and a back focal plane 618. The front focal plane 616 is upstream of the second lens 610 and the back focal plane 618 is downstream of the second lens 610. Normals of the front and back focal planes of each of the first and second lenses 608, 610 are parallel to the optical axis 602 and a distance from each of the front and back focal planes to the respective first or second lens is equal to the focal length f of the respective lens. In this example, the display device 604 is positioned substantially at the front focal plane 612 of the first lens 608. In this example, the front focal plane 616 of the second lens 610 is substantially coplanar with the back focal plane 614 of the first lens 608. In this example, the waveguide 611 is arranged such that back focal plane 618 of the second lens 610 is between the first and second surfaces of the waveguide 622, 624. In the example shown in FIG. 6, the focal length f of the first and second lenses 608, 610 is the same. As such, the optical relay forms a 4f system (i.e. the length of the optical relay is equal to four times the focal length of either the first and second lens 608, 610). However, in other embodiments, the focal length of the first lens 608 may be different to the focal length of the second lens 610. In such cases, the optical relay may form a magnifying (or demagnifying) telescope.

The optical system 600 further comprises a coherent light source such as a laser. The coherent light source is not shown in FIG. 6. In operation of the optical system 600, the coherent light is arranged to illuminate the display device 604. Said light may thus be spatially modulated in accordance with the hologram of the picture displayed on the display device. The spatially modulated light may be received by the first lens 608 and relayed to the second lens 610. A holographic reconstruction 626 of the picture is formed at the back focal plane 612 of the first lens 608, between the first and second lenses 608, 610. The second lens 610 relays the spatially modulated light to the waveguide 611. As described in relation to earlier Figures, the waveguide 611 replicates the light received from the display device so as to form a plurality of replicas or copies of the hologram displayed on display device 604 such that each replica comprises light spatially modulated in accordance with the hologram on the display device. In embodiments, the optical system further comprises a second waveguide (not shown in the drawings) to provide waveguiding and replication in a second direction such that a two-dimensional array of replicas is output by the second waveguide. The spatially modulated light is relayed from the output of the second waveguide to an eye-box/viewing plane (which is expanded as a result of replication achieved by the waveguides). When a viewing system (such as the eye of a user) is placed at the eye-box/at the viewing plane, the viewing system receives the spatially modulated light which forms a virtual image of the picture of the hologram displayed on the display device at a virtual image distance which is encoded in the hologram.

The optical system 600 is able to provide a good virtual image of the picture of the hologram when a viewing system is positioned in the viewing plane/eye-box. However, artifacts may be formed/appear at the viewing plane (i.e. the plane comprising the plurality of replicas). The artifacts may comprise dark bands resulting from the display device being illuminated with non-uniform intensity light and/or may result from the physical features of the display device (for example, scattering off features of the display device). In any case, the artifacts may be replicated by the waveguide(s) to form a repeating pattern of the artifacts at the viewing plane. Thus, while the virtual image of the picture/holographic reconstruction per se may be good quality, the view of the virtual image of the picture at the viewing plane may appear obstructed by the repeating pattern of artifacts. The viewing system may have to effectively “look through” the repeating pattern of artifacts to observe the virtual image.

### Separation of Hologram Image and Holographic Reconstruction Image

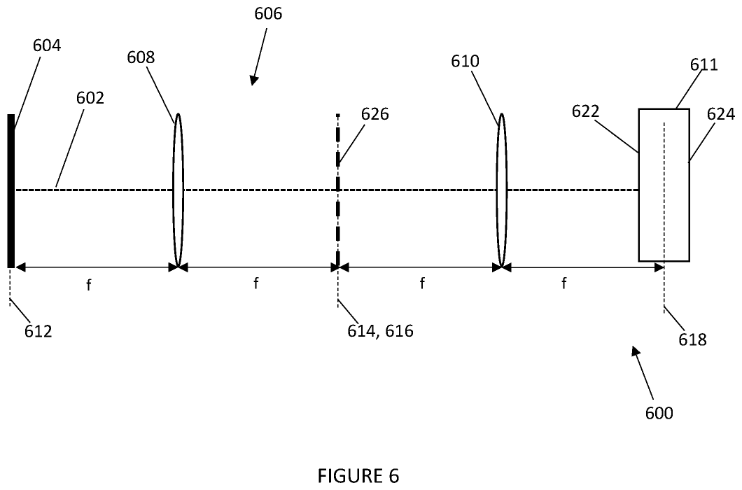

FIG. 7 is a cross-sectional schematic view of the optical components of a first optical system 700 which is arranged such that an image of the hologram/display device is far removed from a virtual image of a holographic reconstruction of the hologram, thus reducing or eliminating the appearance of the above-described artifacts. The first optical system 700 is arranged such that a Fourier transform of the hologram displayed on the display device 704 is coupled into the waveguide 711 (rather the hologram per se). As explained below, this is because of the presence of a lens 750 between a relayed hologram and the waveguide 711.

The optical system 700 comprises an optical axis represented by dotted line 702 in FIG. 7. The optical system 700 comprises a display device 704 which, in this example, is a liquid crystal on silicon spatial light modulator. The display device 704 is arranged to display a hologram of a picture. Downstream of the display device 704 is an optical relay 706. The optical relay 706 comprises a first lens 708 and a second lens 710.

The display device 704 and the optical relay 706 of the optical system 700 are very similar to the display device 604 and optical relay 706 of the optical system 600. For example, the first lens 708 of the optical relay 706 comprises a front focal plane 712 and a back focal plane 714. The front focal plane 712 is upstream of the first lens 708 and the back focal plane 714 is downstream of the first lens 708. The second lens 708 of the optical relay 706 comprises a front focal plane 716 and a back focal plane 718. The front focal plane 716 is upstream of the second lens 710 and the back focal plane 718 is downstream of the second lens 710. Normals of the front and back focal planes of each of the first and second lenses 708, 710 are parallel to the optical axis 702 and a distance from each of the front and back focal planes to the respective first or second lens is equal to the focal length f of the respective lens. In this example, the display device 704 is positioned substantially at the front focal plane 712 of the first lens 708. In this example, the front focal plane 716 of the second lens 710 is substantially coplanar with the back focal plane 714 of the first lens 708. In the example shown in FIG. 7, the focal length f of the first and second lenses 708, 710 is the same. As such, the optical relay forms a 4f system (i.e. the length of the optical relay is equal to four times the focal length f of either the first and second lens 708, 710). However, in other embodiments, the focal length of the first lens 708 may be different to the focal length of the second lens 710. In such cases, the optical relay may be form a magnifying (or demagnifying) telescope.

Unlike the optical system 600, the optical system 700 further comprises an optical component 750 between the second lens 710 and a waveguide 711. The optical component 750 in this example is a (third) lens. In this example, the third lens 750 is a Fourier lens. A front focal plane 754 of the third lens 750 is upstream of the third lens 750 and is substantially co-planar with the back focal plane 718 of the second lens 710. A back focal plane 757 of the third lens 750 positioned between first and second surfaces 722,724 of the waveguide 711.

In this example, the focal length f of the third lens 750 is the same as the focal length f of the first and second lenses 708, 710. As such, the optical relay 706 and the third lens 750 collectively define a 6f system (in which the separation between the front focal plane 712 of the first lens 708 and the back focal plane 757 of the third lens 750 is equal to six times the focal length of the first/second or third lens 708, 710, 752). However, in other examples, the focal length of the third lens 750 may be different to the focal length of the first lens 708 and/or second lens 710.

So, an important difference between the optical system 600 and the optical system 700 according to the disclosure is that the optical system 700 according to the disclosure comprises an additional lens 750 between the display device 704 and the waveguide 711.

Another important difference between the optical system 600 and the optical system 700 is that, in the optical system 700, the hologram displayed on the display device 704 is arranged such that a holographic reconstruction 756 of the picture of the hologram is formed downstream of the display device when the display device 704 is illuminated with coherent light from a coherent light source such as a laser. This is holographic reconstruction 756 which is formed without the use of a physical lens between the display device 704 and the holographic reconstruction 756. Instead, the hologram is calculated to form the holographic reconstruction 756 at this location. In particular, the hologram is calculated/arranged such that the holographic reconstruction 756 is formed such that a distance between the holographic reconstruction 756 and the first lens 708 is less than the focal length f of the first lens 708 while the distance between the display device 704 and the first lens 708 is equal to the focal length f of the first lens 708.

The optical relay 706 is arranged to relay the hologram on the display device to form a relayed hologram 760 downstream of the second lens 710 and to form a relayed holographic reconstruction 758 downstream of relayed hologram 760. The relayed hologram 760 corresponds to the display device (comprising the displayed hologram of the picture). The relayed holographic reconstruction 758 corresponds to the holographic reconstruction 756.

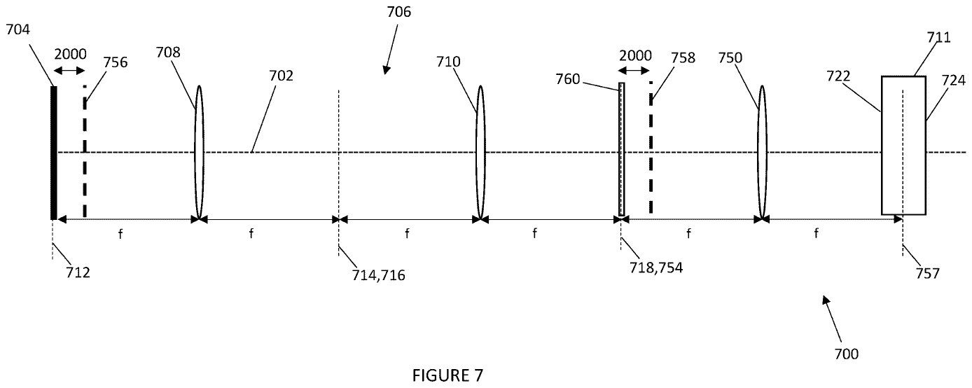

In this example, the relayed holographic reconstruction 758 is formed such that a distance between the relayed holographic reconstruction 758 and the third lens 750 is less than the focal length of the third lens 750 while the distance between the relayed hologram 760 and the third lens 750 is equal to the focal length of the third lens 750. By positioning the relayed hologram 760 and the relayed holographic reconstruction 758 with respect to the third lens 750 in this way, the third lens 750 can form images of the relayed hologram and relayed holographic reconstruction that are far removed from one another. This is explained in more detailed in relation to FIG. 8.

FIG. 8 shows a cross-sectional schematic view of the third lens 750 and the waveguide 711 of FIG. 7 (as well as the relayed hologram 760 and relayed holographic reconstruction 758). These components are shown separately from the other optical components of the optical system 700 (such as the display device 704 and the optical relay 706). FIG. 8 is a schematic ray diagrams showing rays from the relayed hologram 760 and the relayed holographic reconstruction 758.

As the skilled person will understand, a (convex) lens (such as the third lens 750) will form a virtual image of an object at infinity when the object to be imaged is positioned at the focal length of the lens. As above, the relayed hologram 760 is formed (by the optical relay 706) at the focal length f of the third lens 750 (in particular, at the front focal plane 752 of the third lens 750). Thus, the third lens 750 is arranged to form a virtual image of the relayed hologram 760 at infinity. The virtual image at infinity is upstream of the display device 704/third lens 750. The formation of this virtual image is represented by the rays coming from the relayed hologram 760 to the third lens 750 and then extending parallel. Said rays are shown by the broken lines comprising dots and dashes in an alternating configuration in FIG. 8.

The skilled person will also understand that a (convex) lens (such as the third lens 750) will form a virtual image of an object at a finite image distance upstream of said lens when the object to be imaged is positioned such that a distance between the object and the lens is less than the focal length of the lens. As above, the relayed holographic reconstruction 758 is formed (by the optical relay 706) such that the distance between the relayed holographic reconstruction 758 and the third lens 750 is less than the focal length of the third lens 750. In other words, the relayed holographic reconstruction 758 is positioned between the front focal plane 752 of the third lens 750 and the third lens 750 itself. By forming the relayed holographic reconstruction 758 here, the third lens 750 is arranged to form a virtual image 800 of the relayed holographic reconstruction 758 upstream of the third lens 750 and at a finite image distance. The formation of this virtual image 800 is represented by the rays coming from the relayed holographic reconstruction 758 to the third lens 750 and then converging upstream of the third lens 750. Said rays are shown by broken lines comprising dots only in FIG. 8.

Both the virtual image of the relayed hologram 760 and the virtual image 800 of the relayed holographic reconstruction 758 are upstream of the third lens 750. However, the virtual image distance of the virtual image of the relayed hologram 760 is at infinity whereas the virtual image distance of the virtual image 800 of the relayed holographic reconstruction 758 is finite. Thus, the two virtual images are far removed from one another (in fact, the separation between the two virtual images is effectively infinite). The artifacts (described above) may be features in the virtual image of the relayed hologram 760. The appearance of the artifacts may not be present/apparent in the virtual image 800 of the relayed holographic reconstruction 758. The inventors have found that, by separating the two virtual images as described, the prominence of the artifacts in a viewing system's field of view may be substantially reduced or even eliminated. Without wishing to be bound by theory, it is believed that this is because the virtual image of the relayed hologram 760 (comprising the artifacts) is far removed from the virtual image of the relayed holographic reconstruction 758 and, in this case, projected right out to infinity, beyond the virtual image of the relayed holographic reconstruction 758. Thus, the viewing system is not required to “look through” the virtual image of the relayed hologram 760 to view the virtual image of the relayed holographic reconstruction 758.

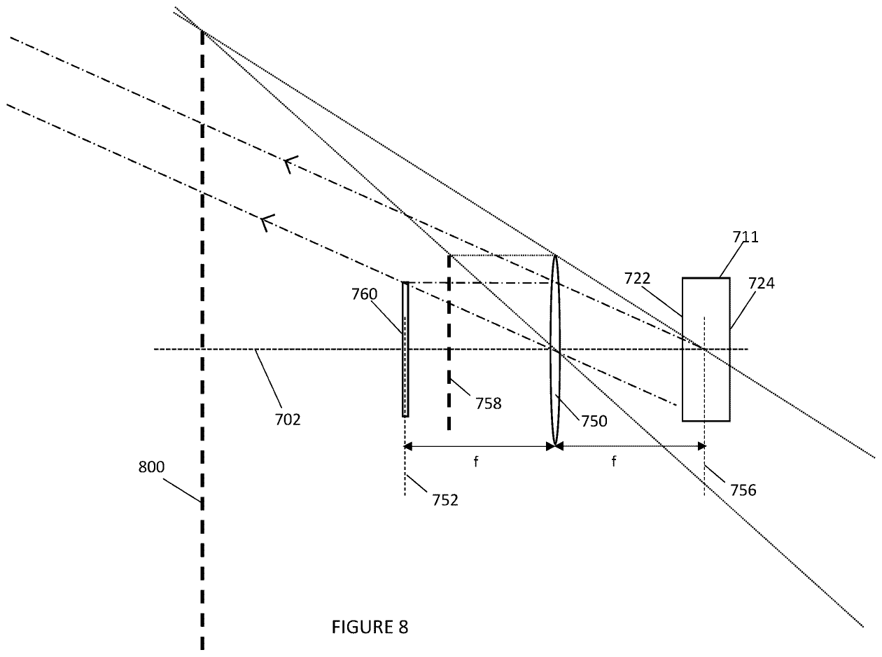

FIG. 9 is a cross-sectional schematic view of the optical components of a second optical system 900 that is arranged such that an image of the hologram/display device is far removed from the virtual image of the holographic reconstruction, thus reducing or eliminating the appearance of the above-described artifacts. The second optical system 900 is similar to the first optical system 700 in that the second optical system 900 is arranged such that a relayed hologram and relayed holographic reconstruction are formed at positions with respect to a third lens so that images of the two are far removed from one another. However, in the second optical system 900, the image of the relayed hologram is a real image formed downstream of the waveguide (for example, behind a viewing system) rather than at infinity and upstream of the third lens. This is described in more detail below.

Like the first optical system 700, the second optical system 900 is arranged such that a Fourier transform of the hologram displayed on the display device 904 is coupled into the waveguide 911 (rather the hologram per se).

The optical system 900 comprises an optical axis represented by dotted line 902 in FIG. 9. The optical system 900 comprises a display device 904 which, in this example, is a liquid crystal on silicon spatial light modulator. The display device 904 is arranged to display a hologram of a picture. Downstream of the display device 904 is an optical relay 906. The optical relay 906 comprises a first lens 908 and a second lens 910. The optical system 900 further comprises a third lens 950.

The display device 904, the optical relay 906 and the third lens 950 of the optical system 900 are very similar to the display device 704, optical relay 706 and third lens of the first optical system 700. For example, the first lens 908 of the optical relay 906 comprises a front focal plane 912 and a back focal plane 914. The front focal plane 912 is upstream of the first lens 908 and the back focal plane 914 is downstream of the first lens 908. The second lens 910 of the optical relay 906 comprises a front focal plane 916 and a back focal plane 918. The front focal plane 916 is upstream of the second lens 910 and the back focal plane 918 is downstream of the second lens 910. Normals of the front and back focal planes of each of the first and second lenses 908, 910 are parallel to the optical axis 902 and a distance from each of the front and back focal planes to the respective first or second lens is equal to the focal length f of the respective lens. In this example, the front focal plane 916 of the second lens 910 is substantially coplanar with the back focal plane 914 of the first lens 908. In the example shown in FIG. 9, the focal length f of the first and second lenses 908, 910 is the same. As such, the optical relay forms a 4f system (i.e. the length of the optical relay is equal to four times the focal length f of either the first and second lens 908, 910). However, in other embodiments, the focal length of the first lens 908 may be different to the focal length of the second lens 910. In such cases, the optical relay may form a magnifying (or demagnifying) telescope. As in the first optical system 700, the third lens 950 is a Fourier lens. A front focal plane 954 of the third lens 950 is upstream of the third lens and is substantially co-planar with the back focal plane 918 of the second lens 910. A back focal plane 957 of the third lens 950 positioned between first and second surfaces of the waveguide 911. In this example, the focal length f of the third lens 950 is the same as the focal length of the first and second lenses 908, 910. As such, the optical relay 906 and the third lens 950 collectively define a 6f system (in which the separation between the front focal plane 912 of the first lens 908 and the back focal plane 957 of the third lens 950 is equal to six times the focal length of the first/second or third lens 908, 910, 952). However, in other examples, the focal length of the third lens 950 may be different to the focal length of the first lens 908 and/or second lens 910.

The key difference between the first optical system 700 and the second optical system 900 is that, in the second optical system 900, the display device 904 is not positioned substantially at the front focal plane 912 of the first lens 908 (as is the case in the first optical system 700). Instead, the distance between the display device 904 and the first lens 908 is greater than the focal length f of the first lens 908. However, like in the first optical system 700, in the second optical system 900, the hologram displayed on the display device 904 is arranged such that a holographic reconstruction 956 of a picture of the hologram is formed downstream of the display device such that a distance between the holographic reconstruction 956 and the first lens 908 is less than the focal length f of the first lens 908. As such, a distance between the display device 904 and the holographic reconstruction 956 in the second optical system 900 is greater than a distance between the display device 704 and the holographic reconstruction 756 in the second optical system 700.

The optical relay 906 is arranged to relay the hologram on the display device to form a relayed hologram 960 downstream of the second lens 910 and to form a relayed holographic reconstruction 958 downstream of relayed hologram 960. The relayed hologram 960 corresponds to the display device (comprising the displayed hologram of the picture). The relayed holographic reconstruction 958 corresponds to the holographic reconstruction 956.

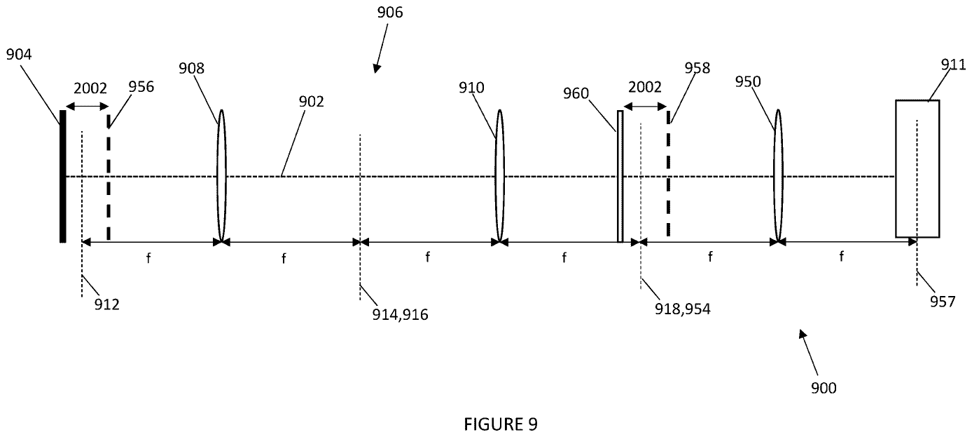

In this example, the relayed holographic reconstruction 958 is formed such that a distance between the relayed holographic reconstruction 958 and the third lens 950 is less than the focal length of the third lens 950 while the distance between the relayed hologram 960 and the third lens 950 is greater than the focal length of the third lens 950. By positioning the relayed hologram 960 and the relayed holographic reconstruction 986 with respect to the third lens 950 in this way, the third lens 950 can form images of the relayed hologram and relayed holographic reconstruction that are far removed from one another. This is explained in more detailed in relation to FIG. 10.

FIG. 10 shows a cross-sectional schematic view of the third lens 950 and the waveguide 911 of FIG. 9 (as well as the relayed hologram 960 and relayed holographic reconstruction 958). These components are shown separately from the other optical components of the optical system 900 (such as the display device 904 and the optical relay 906). FIG. 10 is a schematic ray diagrams showing rays from the relayed hologram 960 and the relayed holographic reconstruction 958.

As the skilled person will understand, a (convex) lens (such as the third lens 958) will form a real image of an object when the object to be imaged is positioned beyond the focal length of the lens. Said real image will be formed at a finite image distance downstream of said lens. As above, the relayed hologram 960 is formed (by the optical relay 906) beyond the focal length f of the third lens 950. In particular, the distance between the relayed hologram 960 and the third lens 950 is greater than the focal length f of the third lens. Thus, the third lens 950 is arranged to form a real image 1002 of the relayed hologram 960 downstream of the third lens 950. The formation of this real image 1002 is represented by the rays coming from the relayed hologram 960 to the third lens 950 and then converging at a point which is downstream of the third lens 950 (and waveguide 911). Said rays are shown by the broken lines comprising dots and dashes in an alternating configuration in FIG. 10.

In both the first and second optical systems 700,900, the relayed holographic reconstruction is formed (by the optical relay) such that the distance between the relayed holographic reconstruction and the third lens is less than the focal plane of the third lens. Thus, like in the first optical system 700, in the second optical system 900, the third lens 950 is arranged to form a virtual image 1000 of the relayed holographic reconstruction 958 upstream of the third lens 950 and at a finite image distance. The formation of this virtual image 100 is represented by the rays coming from the relayed holographic reconstruction 958 to the third lens 950 and then converging at a point which is upstream of the third lens 950. Said rays are shown by the broken lines comprising dots only in FIG. 10.

So, the third lens 950 (and optical system 900 more generally) is arranged to form a virtual image of the relayed holographic reconstruction 958 upstream of the third lens and a real image of the relayed hologram 960 downstream of the waveguide 911. In this way, the two images (virtual and real) are far removed from one another.

In examples, the real image of the relayed hologram 960 is downstream of a viewing window/eyebox (which is not shown in the Figures but which would be located between the waveguide 911 and the real image of the relayed hologram 960). Thus, because, as above, it is believed that the artifacts are visible/apparent in the image of relayed hologram 960 and not the relayed holographic reconstruction 958, the prominence of the artifacts in a viewing system's field of view may be substantially reduced or even eliminated. In particular, the image of the relayed holographic reconstruction 958 is in front of the viewing system and the relayed hologram 960 is behind the viewing system such that the viewing system is not required to “look through” an image of the relayed hologram (comprising the artifacts) when viewing the virtual image of the holographic reconstruction 958.

The first and second optical systems 700,900 (according to the disclosure) described above each comprise an optical relay 702,902. The optical relay in each example forms a relayed hologram 760,960 and a relayed holographic reconstruction 758,958 of a picture of the hologram. The third lens 750,950 in each examples then forms images of the relayed hologram and relayed holographic reconstruction. Some examples according to the disclosure do not comprise the optical relay. These examples comprise a (single) lens which forms images of the hologram/display device per se and the holographic reconstruction per se, rather than relayed versions of the hologram and holographic reconstruction. However, the principal is substantially the same as previously described in that the hologram/display device and holographic reconstruction are positioned with respect to the (single) lens so that the image of the hologram/display device is far removed from the image of the holographic reconstruction such that the appearance/impact of the above-described artifacts is reduced/eliminated.

### Halo Artifact

The optical systems 700, 900 are arranged such that the respective distance between the display device 704,904 and the holographic reconstruction 756,956 is relatively short. This distance is represented by feature 2000 in the figures. For example, the distance may be 20 millimetres or less. In particular, the holographic reconstruction 756, 956 can be formed very closely to the display device 704, 904 (in the absence of an optical component/lens between the display device and the reconstruction) by using relatively very small contiguous groups of pixels of the display device to form each image point of a holographic reconstruction. The result of this is that a relatively very small number of pixels is used for each sub-hologram. For example, a contiguous group of pixels comprising less than 5% of the total number of pixels of the display device may form each sub-hologram/contiguous group of pixels. For example, each contiguous group may comprise 100,000 pixels or less, optionally less than 25,000 pixels, optionally less than 5,000 pixels, optionally less than 1,000 pixels, optionally less than 500 pixels, optionally less than 200 pixels, optionally less than 100 pixels.

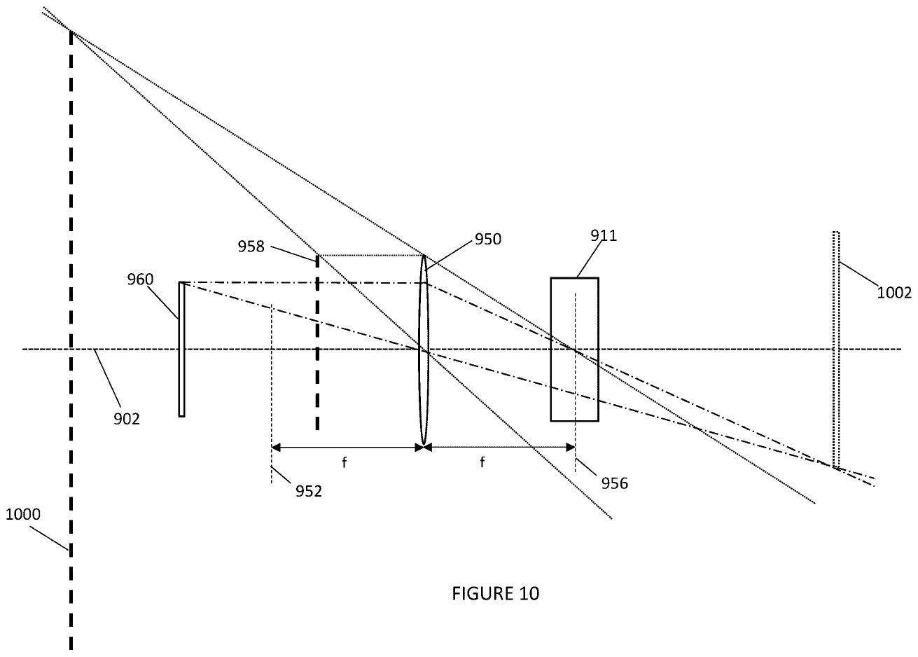

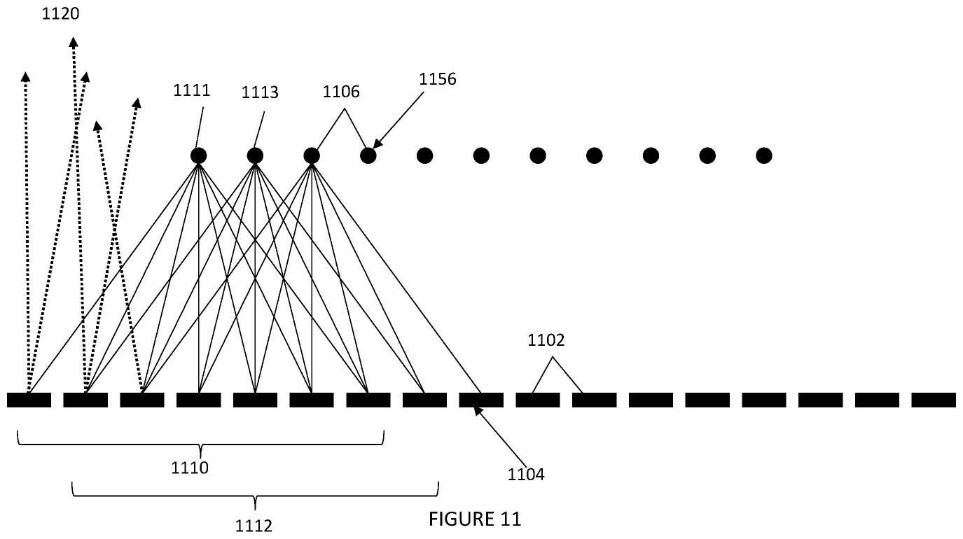

The inventors have unexpectedly found that, although a good quality holographic reconstruction can be formed using small contiguous groups of pixels (as described above), additional artifacts/noise may be apparent to a viewer when the holographic reconstruction is formed relatively close to the display device compared to more conventional optical systems (where the holographic reconstruction may be formed at least 1 metre away from the display device, for example, and when a large proportion/substantially all pixels of the display device contribute to each image point of the holographic reconstruction). The inventors have identified that the additional artifacts/noise are formed by light that is scattered by the display device. The inventors have found that the additional artifacts/noise appears as a halo, referred to herein as the so-called “halo-effect”. The scattering and the halo effect are shown in FIGS. 11 and 12A and 12B respectively.

FIG. 11 is a schematic cross-sectional view of a portion of a pixelated display device 1104 (in this example, a liquid crystal on silicon spatial light modulator) arranged to form image points 1106 of a holographic reconstruction 1156. The display device 1104 comprises a two dimensional array of pixels 1102. However, because FIG. 11 is a schematic view of a cross-section through the normal of the display device, the pixels 1102 extend along a single dimension in FIG. 11. The holographic reconstruction 1156 in FIG. 11 is formed relatively very close to the display device 1103. The holographic reconstruction 1156 comprises a plurality of image points 1106. The pixels 1102 of FIG. 11 are illuminated by (coherent) light. The illumination of the pixels 1102 is not shown in FIG. 11. However, light paths from some of the pixels 1102 (forming some image points 1106) are shown in FIG. 11. In particular, FIG. 11 shows how each image point 1106 of the holographic reconstruction 1156 is formed by a contiguous group of pixels 1102 of the display device 1104. Each pixel 1102 of the display device contributes to a plurality of image points 1106. For example, a first group 1110 of pixels 1102 contributes to a first image point 1111 and a second group 1112 of pixels 1102 contributes to a second image point 1113 of the reconstruction. However, as shown in FIG. 11, most of the pixels 1102 of the first group 1110 are also present in the second group 1112.

Ideally, light illuminating the display device would be diffracted so as to contribute only to intended image points 1106. However, the inventors have found that, in reality, some light will be scattered by the pixels 1102/display device 1104. This scattered light is represented by the dashed arrows 1120 in FIG. 11. The scattered light is not directed to form a particular image point 1106. Instead, the scattered light 1120 forms artifacts/noise in the holographic reconstruction 1156. As described above in relation to the optical systems 700, 900 (for example), the holographic reconstruction 1156 is replicated, imaged and viewable from the viewing window. Thus, the artifacts/noise in the holographic reconstruction 1156 are visible by a viewing system using the optical system. The artifacts/noise may adversely affect the viewing experience.

FIGS. 12A and 12B shows holographic reconstructions including artifacts/noise taking the form of a halo (formed by the scattered light 1120).

FIG. 12A shows a first holographic reconstruction 1256 formed by a display device displaying a first hologram of a first picture (the display device/hologram not being shown in FIG. 12A). The first picture consists of a first content area. Thus, the holographic reconstruction also comprises a first content area 1202. The first content area 1202 is a holographic reconstruction of the picture content contained in the first content area of the first hologram. In FIG. 12A, the picture content is schematically represented by the patterned filled area. If the holographic reconstruction 1256 were a perfect reconstruction of the first picture displayed on the display device (which consists of the first content area and nothing else), then the holographic reconstruction 1256 would consist only of the first content area 1202. However, because of the scattering of light (shown in FIG. 11), a noise area 1204 surrounds the first picture content in the first content area 1202. The noise area 1204 comprises a boundary 1206 having a shape that corresponds to the shape of the first content in the first content area 1202. In this example, the first content in the first content area 1202 is substantially square and so the boundary of the noise area 1204 also has a corresponding square shape. The inventors have found that the intensity of scattered light forming noise at or towards the boundary 1206 of the noise area 1204 is greatest. Thus, the noise area 1204 has the appearance of a halo 1208 (having a shape corresponding to the shape of the first content area 1202). Lower intensity scattered light fills the remainder of the noise area 1204 (between the first content area 1202 and the halo 1208). The inventors have found that the noise has this shape as a result of the scattering light by the pixels, the diffraction angle of the pixels and the distance between the display device and the holographic reconstruction. It should be clear that the noise area 1204 is drawn schematically. In particular, the halo 1208 is exaggerated in FIG. 12A.

FIG. 12B shows a second holographic reconstruction 1258 formed by a display device displaying a second hologram of a second picture (the display device/hologram not being shown in FIG. 12B). The second picture is more complicated than the first picture. In particular, the second picture comprises a plurality of content areas 1222 separated by non-content areas 1224, each content area comprising second picture content. The content areas 1222 and the non-content areas 1224 form a chequerboard pattern. A “halo” is formed by each content area 1222 which sums together to form an inner halo 1225 and an outer halo 1226.

### Hologram Blurring to Reduce Halo

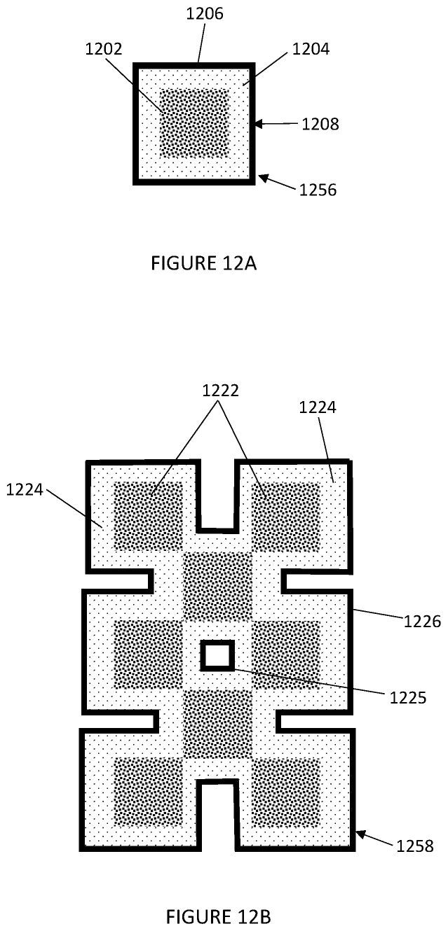

The inventors have developed a software solution for processing a hologram to substantially reduce the halo effect, as will be described in more detail herein. This software solution comprises modifying/changing phase values of the hologram to smooth/blur the hologram. More specifically, the solution comprises blurring/softening diffractive features/structures of the hologram which is highly counterintuitive. A method of processing the hologram, in accordance with the present disclosure, is described in relation to FIGS. 13 to 15.

FIG. 13 schematically represents an array of phase values 1302 of a hologram 1300. When the hologram is displayed on a display device (such as display device 704,904), pixels of the display device will be driven in accordance with phase, or pixel, values 1302 of the hologram. The hologram 1300 comprises a first area 1304 and a second area 1306. The first area 1304 comprises (in fact, consists of) diffractive content. In other words, the phase values 1302 of the first area 1304 area spatially varying such that light incident on the first area 1304 (when the hologram is displayed on a display device) is diffracted. The spatially varying nature of the phase values in the first area is represented by the seemingly random distribution of phase values in the first area 1304. The second area 1306 of the hologram comprises (in fact, consists of) non-diffractive content. In other words, the phase values 1302 of the second area 1304 are not spatially varying, such that the phase values are substantially constant. In this example, each phase value 1302 is in the second area 1304 is equal to zero. The hologram 1300 is a hologram of a picture that has been calculated so as to form a holographic reconstruction of the picture relatively close to the display device, when the hologram is displayed on the display device and appropriately illuminated, as described above. The diffractive content of the first area 1304 spatially modulates light incident thereon to form the holographic reconstruction. The non-diffractive content of the second area 1306 is effectively an artefact of the fact that the hologram has been calculated to form the holographic reconstruction so close to the device, as has been described above. Also as described above, the presence of the first area (comprising diffractive content) and the second area (comprising non-diffractive content) in the hologram means that there is a relatively sudden and large change in phase at a border between the first area and the second area. The method according to the present disclosure smooths or blurs the hologram in a boundary area comprising the border to reduce the sudden/large change in phase.

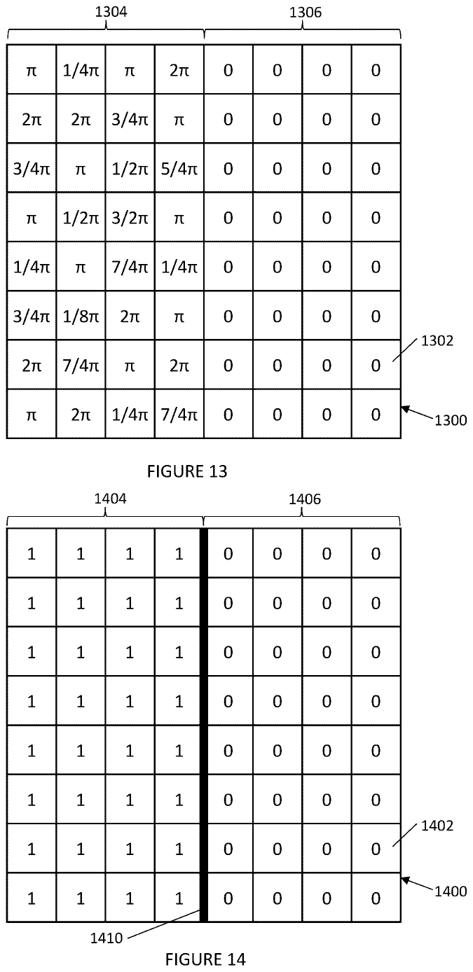

In examples, the method first comprises detecting the border between the first area 1304 and the second area 1306. In examples, the step of detecting the border initially comprises a) applying a binary filter to the hologram to output a binary hologram; b) determining/detecting the border in the binary hologram when a gradient or derivative of the change of phase values in the binary hologram is non-zero; and c) applying the detected border to the (original) hologram 1300. Steps a) and b), above, of detecting the border are shown in FIG. 14.

FIG. 14 shows a binary hologram 1400, calculated using the (original) hologram 1300 of FIG. 13. The binary hologram 1400 of FIG. 14 has been calculated by applying a binary (or two-value) filter to each phase value 1302 of the hologram 1300. The binary filter is arranged to receive, as input a respective value 1302 of the hologram. The binary filter is arranged to compare the input value to a predetermined value. In this example, the predetermined value is zero. If the input value is not equal to the predetermined value (i.e. not equal to zero), the binary function is arranged to output a first value. If the input value is equal to the predetermined value (i.e. equal to zero), the binary function is arranged to output a second value. In this example, the first value is 1 and the second value is 0. So, phase values in a first area 1404 of the binary hologram 1400 (corresponding to the first area 1304 of the first hologram 1300) are equal to one and the phase values in a second area 1406 of the binary hologram 1400 (corresponding to the second area 1306 of the first hologram 1300) are equal to zero.

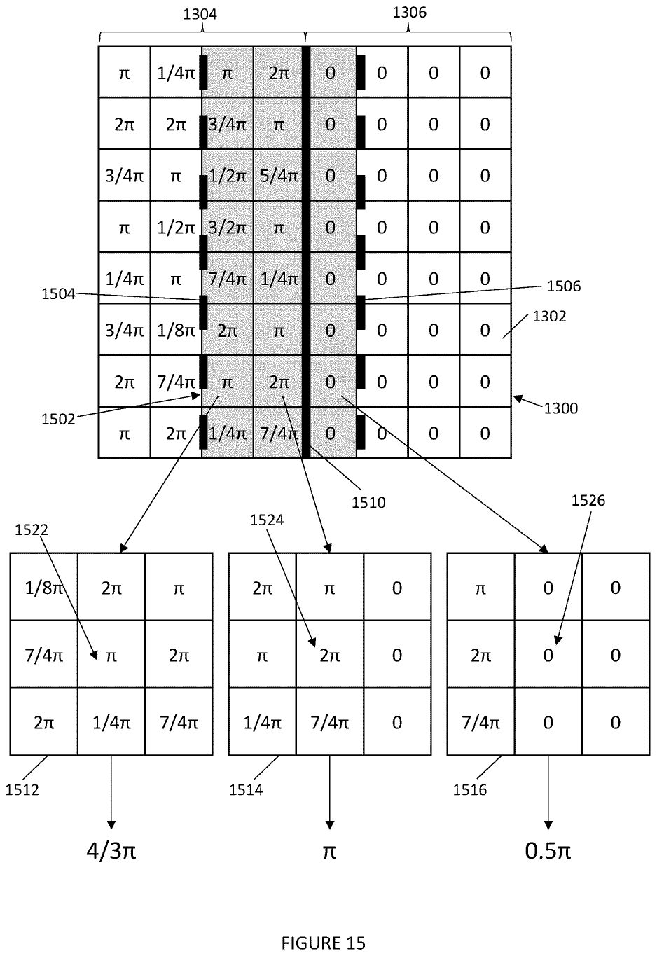

A border 1410 between the first area 1404 and the second area 1406 is detected based on the changes between adjacent phase values 1402 in the binary hologram 1400. For pairs of (adjacent) pixels within the first area 1404, the change is zero (because both pixels in the pair are equal to one). For pairs of (adjacent) pixels within the second area 1406, the change is also zero (because both pixels in the pair area equal to zero). Only at a border between the first area 1404 and the second area 1406 (such that the pair of pixels comprises one pixel from the first area 1404 and one pixel from the second area 1406) is the change non-zero. Thus, non-zero changes can be used to detect the location of a border 1410 (represented by the thick black line in FIG. 14) between the first and second area 1404, 1406 in the binary hologram 1400. The border 1410 will have a corresponding location in the (original) hologram 1300. So, the detected border 1410 (detected on the binary hologram 1400) can be applied to the original hologram 1300. This is shown in FIG. 15, which shows a detected border 1510 superimposed on/applied to the hologram 1300.

FIG. 15 also represents how a hologram blurring function can be applied to a boundary area 1502 of the hologram to blur/smooth the phase values of the hologram in that boundary area 1502, to reduce the magnitude of changes in phase values at the border 1510 between the first area 1304 and the second area 1306. In this example, the boundary area 1502 has a first edge 1504 and a second edge 1506 opposite to the first edge 1504. The first edge 1504 overlaps the first area 1304 of the hologram. The second edge 1506 overlaps the second area 1306 of the hologram. A thickness of the boundary area 1502 is defined between the first edge 1504 and the second edge 1506. In this example, the thickness is three phase values 1302/pixel values.

In this example, the hologram blurring function is a box blur filter having a 3 by 3 kernel. In other words, when the hologram blurring function is applied to a phase value (of the boundary area 1502), the hologram blurring function is arranged to determine the mean average value of a 3 by 3 array of phase values. The 3 by 3 array of phase values includes the phase value to which the hologram blurring function has been applied and 8 other neighbouring phase values. In this example, the 3 by 3 array of phase values is centred on the phase value to which the hologram blurring function has been applied (i.e. the input phase value). Thus, the remaining 8 phase values surround the input phase value. The hologram blurring function is arranged to output the mean phase value to replace the input phase value with the mean phase value in a modified hologram. FIG. 15 exemplifies the application of the box blur filter to a row of 3 phase values of the boundary area 1502. The row of 3 phase values comprises the values π, 2π and 0. The border 1510 is between the phase values 2π and 0. Thus, in the original, or unprocessed, hologram, this row comprises a sudden phase jump of 2π at the border 1510. The box blur filter is applied to each phase value of the row in turn. This is represented by 3×3 arrays 1512 to 1516 respectively, with array 1512 being the 3×3 array of phase values when the box blur filter is applied to phase value 1522 (π), array 1514 being the 3×3 array of phase values when the box blur filter is applied to phase value 1524 (2π), and array 1516 being the 3×3 array of phase values when the box blur filter is applied to phase value 1526 (0). In each case, the box blur filter outputs a mean average phase value. Roughly speaking, these output values are 4/3π, π and 0.5π respectively. These output values replace the respective input values in a modified hologram. The phase changes between adjacent output phase values in the row of three are smaller than in the input row of three values. In particular, the large 2π change between two pixels has been spread (or blurred or smoothed). This process is repeated for each pixel in the boundary area 1502. A modified hologram is output in which each pixel in the boundary area 1502 has been replaced with a mean average value calculated using the box blur function.

The inventors have found that processing the hologram according to the method as described advantageously significantly reduces the above described so-called halo effect.

It should be clear that the above described example is illustrative and not limiting. In particular, FIGS. 13 to 15 show 64 pixel holograms. However, it should be clear that this method applies equally to holograms of any size (usually, the holograms may be much larger, for example 512 by 512 pixels). Similarly, FIG. 15 shows a boundary area 1502 that is only 3 pixels in thickness and a hologram blurring function comprising a 3 by 3 kernel, whereas in most real examples the boundary area 1502 and the kernel would be much larger. For example, the inventor has found that a roughly 50 pixel thick boundary area, in combination with a 50 by 50 kernel, provides a good balance between significantly reducing the halo effect without modifying so many phase values of the hologram that image quality of the reconstruction is significantly adversely affected. Furthermore, the example shown in FIGS. 13 to 15 is a simple one, in which a single, straight border exists between a single first area 1304 and a second area 1306. However, it should be clear to the skilled reader that the same method is applicable to more complex hologram patterns. For example, a hologram of the used for the holographic reconstruction of FIG. 12B may comprise a plurality of different “first” areas, each comprising different diffractive content and each bordering one or more “second” areas comprising non-diffractive content. The border between these areas may be complex (i.e. not a single straight line) and there may be multiple borders. However, this complex border can be identified in the same way as in FIG. 15, and a hologram blur function applied accordingly. Furthermore, in the above described example, border detection comprises the use of two-value filter to form a binary hologram. However, the skilled reader should appreciate that other methods are available for detecting or determining the border. For example, the border could be detected in the (original) hologram 1300 using an algorithm such as might be used in image processing for edge detection.

A method of hologram processing has been described above. However, it should be clear to the skilled reader, that a light engine can be provided that is arranged to perform this method.

### Additional Features

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

1. A light engine comprising a display device, wherein the display device comprises an array of pixels, wherein each pixel is arranged for applying a phase delay to light incident thereon, and wherein the light engine is configured to:
receive a hologram of a picture, wherein the hologram comprises an array of pixel values, wherein the hologram comprises a first area comprising diffractive content and a second area comprising non-diffractive content, and wherein the first area is adjacent to the second area;
apply a hologram blurring function to the hologram in a boundary area of the first and second areas to output a modified hologram; and
wherein the hologram blurring function is arranged to change a gradient of the pixel values across the boundary area.

2. The light engine of claim 1, wherein the hologram comprises a plurality of pairs of adjacent pixel values, wherein each pair of pixel values comprises a first pixel value of the first area and a second pixel value of the second area, and wherein, for each pair of pixels, the hologram blurring function is arranged to reduce a difference between the first pixel value and the second pixel value of the respective pair of pixels.

3. The light engine of claim 1, wherein the boundary area comprises (i) a first edge that is disposed within the first area and (ii) a second edge, opposite to the first edge, that is disposed within the second area; and
wherein the hologram blurring function is arranged such that a pixel value change associated with the boundary of the modified hologram is greater than that of a corresponding boundary of the hologram from which the modified hologram was based.

4. The light engine of claim 3, wherein a thickness of the boundary area is defined as a distance between the first edge and the second edge; and
wherein the thickness of the boundary area is 20% or less than a width of the display device.

5. The light engine of claim 4, wherein the thickness of the boundary area is one of (i) 5 pixels or greater, (ii) 10 pixels or greater, or (iii) 50 pixels or greater.

6. The light engine of claim 4, wherein the thickness of the boundary area is one of (i) 1000 pixels or less, (ii) 500 pixels or less, or (iii) 200 pixels or less.

7. The light engine of claim 1, wherein the light engine is arranged to detect a border between the first area and the second area.

8. The light engine of claim 7, wherein the light engine is arranged to detect the border based on the pixel values of the hologram.

9. The light engine of claim 7, wherein the light engine is arranged to apply a binary filter to the hologram before detecting the border to output a binary hologram.

10. The light engine of claim 9, wherein the light engine is arranged to detect the border based on when a change or derivative of the pixel values of the binary hologram exceeds a threshold.

11. The light engine of claim 1, wherein applying the hologram blurring function comprises applying the hologram blurring function to each pixel value of the boundary area.

12. The light engine of claim 1, wherein the hologram blurring function is arranged to output a mean average value of neighbouring pixel values for each pixel value that the hologram blurring function is applied to.

13. The light engine of claim 12, wherein the boundary area of the modified hologram comprises mean average pixel values calculated using the hologram blurring function.

14. The light engine of claim 1, wherein the hologram blurring function comprises one of (i) a kernel, or (ii) a two-dimensional kernel.

15. The light engine of claim 14, wherein a width and/or a depth of the kernel is substantially equal to a thickness of the boundary area.

16. The light engine of claim 1, wherein the hologram is arranged such that the display device spatially modulates light in accordance with the hologram to form a holographic wavefront arranged to form a holographic reconstruction comprising a plurality image points.

17. The light engine of claim 16, wherein the hologram is arranged such that individual image points of the holographic reconstruction are formed using a contiguous group of pixels of the display device.

18. The light engine of claim 17, wherein each contiguous group of pixels comprises one of (i) less than 100,000 pixels, or (ii) less than 25,000 pixels.

19. The light engine of claim 17, wherein each contiguous group of pixels comprises less than 5% of a total number of pixels of the display device.

20. A method of processing a hologram, the method comprising:
receiving a hologram of a picture, wherein the hologram comprises an array of pixel values, wherein the hologram comprises a first area comprising diffractive content and a second area comprising non-diffractive content, and wherein the first area is adjacent to the second area;
applying a hologram blurring function to the hologram in a boundary area of the first and second areas to output a modified hologram; and
wherein the hologram blurring function is arranged to change a gradient of the pixel values in the boundary area.

21. A diffractive structure comprising an array of pixel values, wherein the diffractive structure is arranged to spatially modulate light incident thereon to form a holographic wavefront, and wherein the holographic wavefront is arranged to form a holographic reconstruction of a picture that is encoded in the diffractive structure;
wherein the diffractive structure comprises (i) a first area comprising diffractive content, (ii) a second area comprising non-diffractive content, and (iii) a blurred area between the first area and the second area, wherein the blurred area comprises (a) a first edge disposed on the first area and (b) a second edge opposite to the first edge and disposed on the second area; and
wherein the diffractive structure is arranged such that pixel values in the blurred area progressively change with distance from the second edge.
